(19) United States
(12) Patent Application Publication
(10) Pub. No.: US 2026/0361336 A1
(43) Pub. Date: Nov. 12, 2026

(54) FREQUENCY HOPPING TRANSMISSION METHOD AND APPARATUS

(71) Applicant: VIVO MOBILE COMMUNICATION CO., LTD., Dongguan (CN)

(72) Inventor: Na LI, Dongguan (CN)

(21) Appl. No.: 19/727,430

(22) Filed: Jul. 1, 2026

Related U.S. Application Data
(63) Continuation of application No. PCT/CN2025/070577, filed on Jan. 3, 2025.

(30) Foreign Application Priority Data
Jan. 4, 2024 (CN) 202410015963.2

(51) Int. Cl. H04B 1/7136

(52) U.S. Cl. CPC H04B 1/7136

(57) ABSTRACT

A frequency hopping transmission method and apparatus are disclosed in the field of communication technologies. The frequency hopping transmission method according to an embodiment of this application includes: determining, by a terminal based on target information or a predefined rule, a frequency domain unit in which each hop of at least two hops of a first transmission is located; where the target information is used for indicating the frequency domain unit in which each hop of the at least two hops is located; the predefined rule is used for determining a frequency domain unit in which at least one hop of the at least two hops is located; and the first transmission supports frequency hopping transmission on different frequency domain units; and performing, by the terminal, transmission on the frequency domain unit in which at least one hop of the at least two hops is located.

### CROSS-REFERENCE TO RELATED APPLICATIONS

This application is a bypass continuation application of International Application No. PCT/CN2025/070577, filed on Jan. 3, 2025, which claims the benefit of and priority to Chinese Patent Application No. 202410015963.2 filed on Jan. 4, 2024, the contents of both of which being incorporated by reference in there entireties herein as part of this application.

### TECHNICAL FIELD

This application relates to the field of communication technologies and, more specifically, relates to a frequency hopping transmission method and apparatus.

### BACKGROUND

In the related art, uplink and downlink transmissions are each limited to a single bandwidth part (BWP) on a cell, where a BWP is a segment of continuous frequency resources. To obtain frequency diversity gain, improve interference resistance of uplink transmission, and enhance uplink transmission performance, frequency hopping is supported for physical uplink control channel (PUCCH), physical uplink shared channel (PUSCH), and sounding reference signal (SRS) transmissions. Specifically, an uplink transmission is divided into two or more hops, with each hop transmitted at a different frequency-domain position within the same BWP.

### SUMMARY

According to a first aspect, a frequency hopping transmission method is provided, executed by a terminal. The method includes:
determining, by the terminal based on target information or a predefined rule, a frequency domain unit in which each hop of at least two hops of a first transmission is located; where the target information is used for indicating a frequency domain unit in which at least one hop of the at least two hops is located; the predefined rule is used for determining the frequency domain unit in which at least one hop of the at least two hops is located; and the first transmission supports frequency hopping transmission on different frequency domain units; and
performing, by the terminal, transmission on the frequency domain unit in which at least one hop of the at least two hops is located.

According to a second aspect, a frequency hopping transmission apparatus is provided, including:
a first determining module configured to determine, based on target information or a predefined rule, a frequency domain unit in which each hop of at least two hops of a first transmission is located; where the target information is used for indicating a frequency domain unit in which at least one hop of the at least two hops is located; the predefined rule is used for determining the frequency domain unit in which at least one hop of the at least two hops is located; and the first transmission supports frequency hopping transmission on different frequency domain units; and
a first transmission module configured to perform transmission on the frequency domain unit in which at least one hop of the at least two hops is located.

According to a third aspect, a terminal is provided. The terminal includes a processor and a memory, where the memory stores a program or instructions capable of running on the processor, and the program or instructions, when executed by the processor, implement the steps of the method according to the first aspect.

According to a fourth aspect, a terminal is provided, including a processor and a communication interface, where the processor is configured to determine, based on target information or a predefined rule, a frequency domain unit in which each hop of at least two hops of a first transmission is located; where the target information is used for indicating a frequency domain unit in which at least one hop of the at least two hops is located; the predefined rule is used for determining the frequency domain unit in which at least one hop of the at least two hops is located; and the first transmission supports frequency hopping transmission on different frequency domain units; and
the communication interface is configured to perform transmission on the frequency domain unit in which at least one hop of the at least two hops is located.

According to a fifth aspect, a readable storage medium is provided, where a program or instructions stored on the readable storage medium, and the program or instructions, when executed by a processor, implement the steps of the method according to the first aspect.

According to a sixth aspect, a chip is provided. The chip includes a processor and a communication interface, where the communication interface is coupled to the processor, and the processor is configured to run a program or instructions to implement the method according to the first aspect.

According to a seventh aspect, a computer program/program product is provided, where the computer program/program product is stored in a storage medium, and the program/program product is executed by at least one processor to implement the steps of the frequency hopping transmission method according to the first aspect.

### BRIEF DESCRIPTION OF DRAWINGS

FIG. 1 is a schematic diagram of a wireless communication system to which embodiments of this application are applicable;

FIG. 2 is a schematic diagram showing that a base station implements bandwidth change by activating different BWPs for a UE in the related art;

FIG. 3 is a schematic flowchart of a frequency hopping transmission method according to an embodiment of this application;

FIG. 4 is a first schematic diagram of a frequency domain unit index of each hop of PUCCH transmission according to an embodiment of this application;

FIG. 5 is a second schematic diagram of a frequency domain unit index of each hop of PUCCH transmission according to an embodiment of this application;

FIG. 6 is a third schematic diagram of a frequency domain unit index of each hop of PUCCH transmission according to an embodiment of this application;

FIG. 7 is a fourth schematic diagram of a frequency domain unit index of each hop of PUCCH transmission according to an embodiment of this application;

FIG. 8 is a fifth schematic diagram of a frequency domain unit index of each hop of PUCCH transmission according to an embodiment of this application;

FIG. 9 is a schematic structural diagram of a frequency hopping transmission apparatus according to an embodiment of this application; and

FIG. 10 is a schematic structural diagram of a terminal according to an embodiment of this application.

### DESCRIPTION OF EMBODIMENTS

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

The terms “first”, “second”, and the like in this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, objects distinguished by “first” and “second” are generally of a same type, and the quantities of the objects are not limited, for example, there may be one or more target objects. In addition, “or” in this application represents at least one of connected objects. For example, “A or B” covers three schemes, that is, scheme 1: including A and not including B; scheme 2: including B and not including A; and scheme 3: including both A and B. The character “/” generally indicates that the associated objects have an “or” relationship.

The term “indication” in this application may be a direct indication (or explicit indication) or an indirect indication (or implicit indication). A direct indication may be understood as a sender explicitly informing a receiver of content such as specific information, an operation to be performed, or a request result in a sent indication; an indirect indication may be understood as a receiver determining corresponding information based on an indication sent by a sender, or making a judgment and determining an operation to be performed, a request result, or the like based on a judgment result.

It should be noted that technologies described in the embodiments of this application are not limited to a long term evolution (LTE)/LTE-Advanced (LTE-A) system, and may also be applied to other wireless communication systems, for example, code division multiple access (CDMA), time division multiple access (TDMA), frequency division multiple access (FDMA), orthogonal frequency division multiple access (OFDMA), single-carrier frequency-division multiple access (SC-FDMA), and other systems. The terms “system” and “network” are often used interchangeably in the embodiments of this application. The technologies described may be used in the above-mentioned systems and radio technologies as well as other systems and radio technologies. In the following descriptions, a new radio (NR) system is described for illustration purpose, and NR terms are used in most of the following descriptions, although these technologies may also be applied to other systems than an NR system, for example, a 6^{th} generation (6G) communication system.

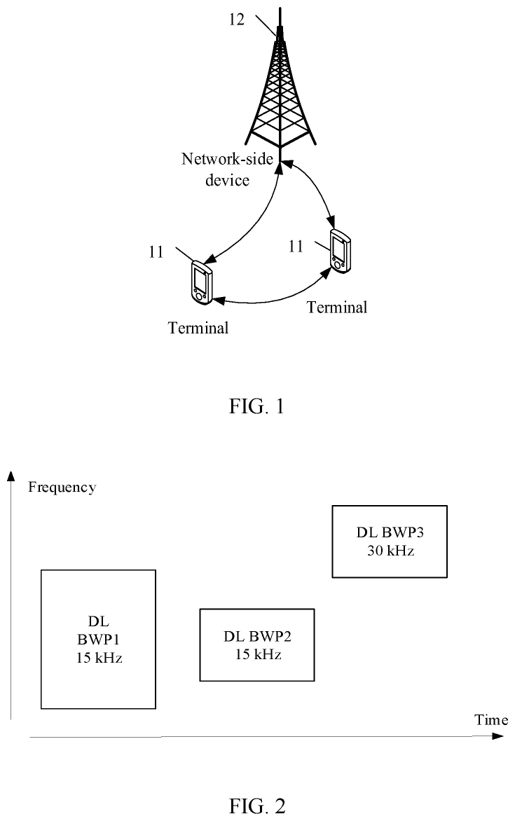

FIG. 1 is a block diagram of a wireless communication system to which embodiments of this application are applicable. The wireless communication system includes a terminal 11 and a network-side device 12. The terminal 11 may be a terminal-side device such as a mobile phone, a tablet personal computer, a laptop computer, a notebook computer, a personal digital assistant (PDA), a palmtop computer, a netbook, an ultra-mobile personal computer (UMPC), a mobile internet device (MID), an augmented reality (AR) or virtual reality (VR) device, a robot, a wearable device, a flight vehicle, vehicle user equipment (VUE), ship-borne equipment, pedestrian user equipment (PUE), smart household (home devices with wireless communication functions, such as refrigerators, televisions, washing machines, or furniture), a game console, a personal computer (PC), a teller machine, or a self-service machine. The wearable device includes a smartwatch, a smart band, smart earphones, smart glasses, smart jewelry (a smart bangle, a smart bracelet, a smart ring, a smart necklace, a smart leglet, a smart anklet, and the like), a smart wristband, smart clothing, or the like. The vehicle user equipment may also be referred to as an in-vehicle terminal, an in-vehicle controller, an in-vehicle module, an in-vehicle component, an in-vehicle chip, an in-vehicle unit, or the like. It should be noted that the terminal 11 is not limited to a specific type in the embodiments of this application. The network-side device 12 may include an access network device or a core network device. The access network device may also be referred to as a radio access network (RAN) device, a wireless access network function, or a wireless access network unit. The access network device may include a base station, a wireless local area network (WLAN) access point (AP), a wireless fidelity (Wi-Fi) node, or the like. The base station may be referred to as a NodeB (NB), an evolved NodeB (eNB), a next generation NodeB (the next generation Node B, gNB), a new radio NodeB (New Radio Node B, NR Node B), an access point, a relay base station (RBS), a serving base station (SBS), a base transceiver station (BTS), a radio base station, a radio transceiver, a basic service set (BSS), an extended service set (ESS), a home NodeB (HNB), a home evolved NodeB (home evolved Node B), a transmission reception point (TRP), or other suitable terms in the field. Provided that the same technical effect is achieved, the base station is not limited to specific technical terms. It should be noted that in the embodiments of this application, only the base station in the NR system is used as an example for description, but a specific type of the base station is not limited.

The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function unit (PCRF), an edge application server discovery function (EASDF), a unified data management (UDM), a unified data repository (UDR), a home subscriber server (HSS), a centralized network configuration (CNC), a network repository function (NRF), a network exposure function (NEF), a local NEF (L-NEF), a binding support function (BSF), an application function (AF), or the like. It should be noted that in the embodiments of this application, only the core network device in the NR system is used as an example for description, but a specific type of the core network device is not limited.

For clearer understanding of the embodiments of this application, the following first describes some related background art.

A mobile communication system needs to adapt to more diverse scenarios and service requirements. For example, main scenarios of 5G include enhanced mobile broadband (eMBB), ultra-reliable and low latency communications (URLLC), and massive machine type communications (mMTC). These scenarios require the system to have high reliability, low latency, large bandwidth, and wide coverage. For different application scenarios, transmission bandwidth required by a terminal varies. In NR, a base station may schedule the terminal to perform transmission on different bandwidth parts based on requirements.

In NR, a network configures one or more bandwidth parts (BWP) for user equipment (UE) for data transmission. The BWP is a segment of contiguous resources in frequency domain. The base station implements dynamic bandwidth change by activating different BWPs for the UE. FIG. 2 is a schematic diagram showing that a base station implements bandwidth change by activating different BWPs for a UE in the related art. As shown in FIG. 2, at a first time, the UE has a large amount of traffic, and the base station activates a large bandwidth (BWP1) for the UE. At a second time, the UE has a small amount of traffic, and the base station activates a small bandwidth (BWP2) for the UE, which needs to meet only basic communication requirement. At a third moment, the system finds that there is large-scale frequency selective fading in a bandwidth where BWP1 is located, or resources within a frequency range of BWP2 are relatively scarce, and thus instructs the UE to activate a new bandwidth (BWP3).

Each BWP may correspond to different configuration parameters, for example, including subcarrier spacing, BWP position and bandwidth, and cyclic prefix (CP).

A sub-3 GHz spectrum has advantages such as low penetration loss, and plays an important role in cellular network deployment due to its good coverage. On the one hand, compared with a C-band, the sub-3 GHz spectrum is fragmented and allocated to international mobile telecommunications (IMT), and due to competition between mobile operators, each spectrum block has relatively narrow bandwidth. On the other hand, almost all operators around the world have multiple sub-3 GHz bands (such as 700 MHz, 800 MHz, 900 MHz, 1.4 GHz, 1.8 GHZ, 2.1 GHZ, 2.3 GHZ, or 2.6 GHz bands). If these non-contiguous spectra can be effectively aggregated to form a “single” carrier with considerable bandwidth, all operators can benefit.

### I. PUCCH Resource Configuration

In NR R15, during uplink carrier aggregation (CA), a maximum of two physical uplink control channel (PUCCH) groups (a primary PUCCH group and a secondary PUCCH group) may be configured, and PUCCH configuration and transmission in each PUCCH group are performed separately. In one PUCCH group, PUCCH resources can be configured and transmitted only on a primary cell (Pcell) or a PUCCH switching secondary cell (PUCCH-sSCell). In Rel-15, a base station may configure a UE-specific PUCCH resource for each UE through radio resource control (RRC) signaling. The UE-specific PUCCH resource is configured on each BWP through an information element (IE) PUCCH-Config (Config). That is, each PUCCH resource is within one BWP.

### II. NR Uplink Transmission with Frequency Hopping (NR UL Transmission with Frequency Hopping)

In an NR system, uplink transmission supports frequency hopping transmission. Simply put, frequency hopping means that uplink resource blocks in different orthogonal frequency division multiplexing (OFDM) symbols can be transmitted on different subcarriers to avoid interference and obtain frequency diversity gain, thereby improving system capacity or coverage.

Frequency hopping for PUCCH, physical uplink shared channel (PUSCH), and sounding reference signal (SRS) is divided into two types: intra-slot and inter-slot. Intra-slot indicates frequency hopping within one time unit, and inter-slot indicates frequency hopping between time units. Therefore, inter-slot frequency hopping is specific only to PUCCH, PUSCH, or SRS that support repetition, such as PUCCH formats 1, 3, and 4.

### III. Configuration of PUCCH Frequency Hopping Mode

A common PUCCH (including PUCCH format 0/1) may be configured only in an initial UL BWP in system information block 1 (SIB1) on a Pcell through a PUCCH identity (ID). A PUCCH resource parameter configuration is obtained through table lookup. Additionally, on this initial UL BWP, if interlace transmission is not configured, the common PUCCH uses an intra-slot frequency hopping mode by default.

A dedicated PUCCH (including PUCCH format 0/1/2/3/4) may be configured on any UL BWP of a Pcell or a PUCCH-sSCell. For non-repetitive PUCCH transmission, an intra-slot frequency hopping mode may be configured through RRC PUSCH configuration.

For a dedicated PUCCH (including PUCCH format 1/3/4), repetitions in N slots may be configured. In this case, an intra-slot frequency hopping mode or an inter-slot frequency hopping mode may be configured through RRC.

In Rel-16, sub-slot-based dedicated PUCCH (including PUCCH format 0/1/2/3/4) is introduced, which does not support PUCCH repetition. An intra-slot frequency hopping mode may be configured through RRC PUCCH configuration.

In Rel-17, repetition of sub-slot-based dedicated PUCCH (including PUCCH format 0/1/2/3/4) is introduced, and an intra-slot frequency hopping mode or an inter-slot frequency hopping mode may be configured through RRC PUCCH configuration.

In Rel-17, for PUCCH repetition, the number of repetitions for each PUCCH may also be determined through RRC PUCCH configuration and DCI indication.

For a common PUCCH, a physical resource block (PRB) index (index) of its first hop is determined by a parameter

$${RB}_{BWP}^{offset}$$

configured in system information, that is,

$${RB}_{BWP}^{offset} + ⌊ \frac{{r}_{PUCCH}}{{N}_{CS}} ⌋ ,$$

and that of its second hop is

$${N}_{BWP}^{size} - 1 - {RB}_{BWP}^{offset} - ⌊ \frac{{r}_{PUCCH}}{{N}_{CS}} ⌋ .$$

For a dedicated PUCCH, PRB indexes of its first hop and second hop are both configured by RRC, that is, configured through parameters startingPRB and secondHopPRB respectively. Regardless of a common PUCCH or a dedicated PUCCH, a PRB index of each hop is relative to a 1st PRB of the UL BWP.

### IV. Configuration of PUSCH Frequency Hopping Mode

PUSCH frequency hopping is applied only when resource allocation type 1 (allocating contiguous PRBs to one PUSCH transmission through a resource indicator value (RIV)).

For a PUSCH scheduled by downlink control information (DCI) 0_0 scrambled by random access response (RAR) UL grant or temporary cell-radio network temporary identity (TC-RNTI), a BWP size is a size of the initial UL BWP. Currently, there is no repetition, the intra-slot frequency hopping mode is enabled by default, and whether to perform intra-slot frequency hopping transmission of the scheduled PUSCH is controlled through a frequency hopping field.

For a message A (Msg A) PUSCH, there is currently no repetition, and whether to perform intra-slot frequency hopping transmission may be determined through msgA-intraSlotFrequencyHopping.

When indicated as repetition type A, for a PUSCH scheduled by DCI 0_0/0_1/0_2 or a type 2 configured grant (CG) PUSCH activated by DCI 0_0/0_1/0_2 (without configuring cg-nrofSlots and cg-nrofPUSCH-InSlot), in the case of no repetition configured, intra-slot frequency hopping mode may be enabled through RRC PUSCH configuration; in the case of repetition configured, intra-slot or inter-slot frequency hopping mode may be enabled through RRC PUSCH configuration. Finally, whether to perform transmission of the scheduled PUSCH in the enabled frequency hopping mode is controlled through a frequency hopping field of DCI.

When indicated as repetition type A, for a type 1 CG PUSCH (without configuring cg-nrofSlots and cg-nrofPUSCH-InSlot), in the case of no repetition configured, intra-slot frequency hopping mode may be enabled through RRC PUSCH configuration; in the case of repetition configured, intra-slot or inter-slot frequency hopping mode may be enabled through RRC PUSCH configuration. Finally, whether to perform transmission of the type 1 CG PUSCH in the enabled frequency hopping mode is controlled through whether a frequency hopping offset field is configured in RRC.

When indicated as repetition type B, for a PUSCH scheduled by DCI 0_0/0_1/0_2 or a type 2 CG PUSCH activated by DCI 0_0/0_1/0_2 (without configuring cg-nrofSlots and cg-nrofPUSCH-InSlot), inter-repetition or inter-slot frequency hopping mode may be enabled through RRC PUSCH configuration. Finally, whether to perform transmission of the scheduled PUSCH in the enabled frequency hopping mode is controlled through a frequency hopping field of DCI.

When indicated as repetition type B, for a type 1 CG PUSCH (without configuring cg-nrofSlots and cg-nrofPUSCH-InSlot), inter-repetition or inter-slot frequency hopping mode may be enabled through RRC PUSCH configuration. Whether to perform transmission of the type 1 CG PUSCH in the enabled frequency hopping mode is controlled through whether a frequency hopping offset field is configured in RRC.

### V. Configuration of SRS Frequency Hopping Mode

Whether to enable frequency hopping for SRS resources is determined by a relationship between higher-layer configured parameters bₕₒₚ and B_{SRS}. For example, when bₕₒₚ≥B_{SRS}, SRS frequency hopping is disabled; otherwise, frequency hopping is enabled. Depending on different parameter values of the frequency hopping configuration, frequency hopping between different symbols in a slot (intra-slot) or between different slots (inter-slot) can be supported.

In the prior art, a carrier of each cell is a segment of contiguous frequency domain resources, and transmission resources are restricted within one BWP on one cell, with a maximum bandwidth of each BWP being 100 MHz. For fragmented spectrums, such as a large number of frequency spectrums in the sub-3 GHz band, in the prior art, to use the fragmented spectrums, carrier aggregation (CA) is a conventional solution for operators and terminals to aggregate spectrums, that is, different contiguous spectrums each are used as a separate carrier. However, the existing CA mechanism treats each carrier as an independent serving cell and assumes that each carrier is independently deployed. Independent management of each carrier brings unnecessary overhead and efficiency loss (such as independent control signaling or common signaling), and also brings unnecessary processes and delays (such as synchronization or SCell addition/release/activation/measurement/mobility). In addition, the CA mechanism benefits only UEs in connected state (RRC_connected), that is, UEs that have completed an RRC connection with the network, but does not benefit UEs in idle state/inactive state (RRC_idle/inactive) (for example, initial access/small data transmission (SDT)).

Therefore, introduction of a flexible cell realizes flexible and efficient utilization of adjacent non-contiguous spectra from the perspective of L1/L2/L3 signaling, procedures, and cell management. This mechanism benefits UEs in connected (CONNECTED) state and idle (IDLE) state, thereby improving user-perceived data rate, energy saving, system capacity, and coverage. It also reduces network management complexity and improves energy efficiency. In addition, these narrow-bandwidth carriers cannot provide frequency diversity gain, or only provide limited frequency diversity gain.

In a case that one cell includes one or more non-contiguous frequency domain resources, if frequency hopping transmission of uplink and downlink channels or signals is performed, no corresponding solutions are available. Therefore, how to implement frequency hopping transmission of uplink and downlink channels or signals is an urgent issue to be addressed.

Embodiments of this application provide a frequency hopping transmission method and apparatus, so as to address an issue of how to implement frequency hopping transmission of uplink and downlink channels or signals in a case that one cell includes one or more non-contiguous frequency domain resources.

The following describes a frequency hopping transmission method according to an embodiment of this application in detail with reference to the accompanying drawings through some embodiments and application scenarios thereof.

The frequency hopping transmission method according to the embodiments of this application may be applied to scenarios of uplink transmission or downlink transmission with frequency hopping between frequency domain units. A terminal determines, based on target information or a predefined rule, a frequency domain unit in which at least one of at least two hops of a first transmission is located; where the target information is used for indicating the frequency domain unit in which at least one hop of the at least two hops is located; the predefined rule is used for determining the frequency domain unit in which at least one hop of the at least two hops is located; and the first transmission supports frequency hopping transmission on different frequency domain units; and the terminal performs transmission on the frequency domain unit in which at least one hop of the at least two hops is located. This implements frequency hopping transmission of the first transmission between different frequency domain units, thereby obtaining relatively high frequency diversity gain or enhancing anti-interference capability for uplink transmission, and improving performance of a communication system.

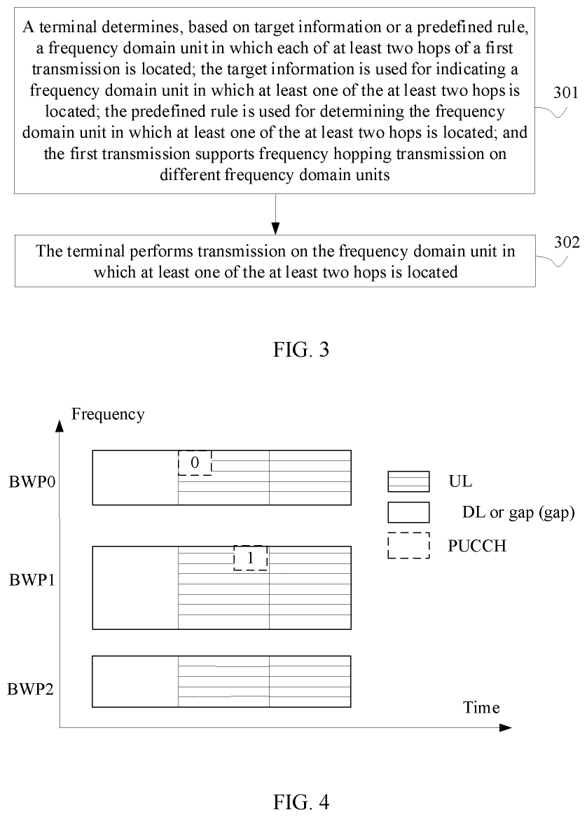

FIG. 3 is a schematic flowchart of a frequency hopping transmission method according to an embodiment of this application. As shown in FIG. 3, the method includes step 301 and step 302.

Step 301: A terminal determines, based on target information or a predefined rule, a frequency domain unit in which each hop of at least two hops of a first transmission is located; where the target information is used for indicating a frequency domain unit in which at least one hop of the at least two hops is located; the predefined rule is used for determining the frequency domain unit in which at least one hop of the at least two hops is located; and the first transmission supports frequency hopping transmission on different frequency domain units.

It should be noted that the embodiments of this application may be applied to scenarios of uplink transmission or downlink transmission with frequency hopping between frequency domain units. The terminal includes but is not limited to the types of the terminal 11 listed above, and the network-side device includes but is not limited to the types of the network-side device 12 listed above, which are not limited in the embodiments of this application.

Specifically, one cell is composed of at least one frequency domain unit, where the frequency domain units may be non-contiguous. A frequency domain unit is a set of contiguous frequency domain resources. The frequency domain unit may be a bandwidth (band), a carrier, a subband, a BWP, or the like. Sizes of the frequency domain units may be different. For example, one cell is composed of four frequency domain units, and sizes of the four frequency domain units are 3 MHz, 10 MHz, 5 MHz and 5 MHz. The first transmission may be uplink transmission or downlink transmission. The first transmission supports frequency hopping transmission on different frequency domain units. For example, the terminal receives first information sent by the network-side device, where the first information is used for the network-side device to configure or indicate that the first transmission supports frequency hopping transmission on different frequency domain units. When frequency hopping is enabled, for example, the network-side device enables frequency hopping transmission through higher layer signaling or dynamic signaling, different hops of the first transmission may be in different frequency domain units. The frequency domain unit may be identified using a frequency domain unit index (index/ID). If the frequency domain unit corresponds to a band, the frequency domain unit may also be identified using a band index. For simplicity, the frequency domain unit is identified using the frequency domain unit index in this application. The method in this application are also applicable to a case where the frequency domain unit is identified using the band index.

Optionally, the terminal receives higher layer signaling or dynamic signaling sent by the network-side device, where the higher layer signaling is used for configuring the target information, and the dynamic signaling is used for indicating the target information.

The network-side device may send higher layer signaling or dynamic signaling to the terminal, and the terminal receives the higher layer signaling or dynamic signaling sent by the network-side device; where the higher layer signaling is used for configuring the target information, and the dynamic signaling is used for indicating the target information; and the target information is used for indicating the frequency domain unit in which at least one hop of the at least two hops is located.

The terminal may also obtain the predefined rule through protocol predefinition, where the terminal may determine, based on the predefined rule, the frequency domain unit in which at least one hop of the at least two hops is located.

Therefore, the terminal may determine, based on the target information or the predefined rule, a frequency domain unit in which one of at least two hops of the first transmission is located.

For example, according to the predefined rule, a frequency domain unit in which a first hop is located is determined, and a frequency domain unit in which each hop starting from a second hop is located is determined by the network-side device through higher-layer signaling configuration or dynamic signaling indication. Alternatively, a frequency domain unit in which each hop starting from a second hop is located is determined according to the predefined rule, and a frequency domain unit in which a first hop is located is determined by the network-side device through higher-layer signaling configuration or dynamic signaling indication.

Optionally, the frequency domain unit in which each hop of at least two hops is located is predefined by a protocol. For example, if the first transmission includes two hops, a frequency domain unit in which a first hop is located is a frequency domain unit that has a smallest frequency domain unit index or a lowest frequency, or is indicated for performing the first transmission among the activated frequency domain units, and a frequency domain unit in which a second hop is located is a frequency domain unit that has a largest frequency domain unit index or a highest frequency among the activated frequency domain units, or a next frequency domain unit or a next available or activated frequency domain unit of the frequency domain unit in which the first hop is located.

Optionally, the target information includes at least one of the following:
(1) First information, used for indicating the frequency domain unit in which each hop of the at least two hops is located.

Specifically, the network configures or indicates the first information. For example, if the first transmission includes two hops, a base station configures or indicates a frequency domain unit index

$${N}_{ID}^{1}$$

of the first hop, and the base station configures or indicates a frequency domain unit index

$${N}_{ID}^{2}$$

of the second hop.

Optionally, in a case that frequency hopping of the first transmission is enabled and the base station configures or indicates the frequency domain unit index of the first hop, the frequency domain unit index

$${N}_{ID}^{2}$$

of the second hop is configured or indicated by the base station or predefined by a protocol.
(2) Second information, used for indicating a frequency domain unit index of a first hop. Specifically, the frequency domain unit index of the first hop may be determined based on the predefined rule, configured by the network, or indicated by the network.
(3) A first frequency domain unit offset; where the first frequency domain unit offset is used for indicating an offset of a frequency domain unit index of each hop starting from a second hop relative to a frequency domain unit index of a first hop, or an offset relative to a frequency domain unit index of a previous hop, or a minimum offset.

Optionally, the first frequency domain unit offset (offset) considers only activated frequency domain units, that is, a frequency domain unit in which a first hop is located is offset backward by offset frequency domain units among the activated frequency domain units.

For example, the base station configures or indicates the frequency domain unit index

$${N}_{ID}^{1} = 1$$

of the first hop, and configures or indicates that the offset of the frequency domain unit index of the second hop relative to the frequency domain unit index of the first hop is 2. The terminal determines, based on the frequency domain unit index

$${N}_{ID}^{1} {N}_{ID}^{1}$$

of the first hop and the offset 2, that the frequency domain unit index of the second hop is

$${N}_{ID}^{1} + 2 = 3.$$

For example, the base station configures or indicates the frequency domain unit index

$${N}_{ID}^{1} = 1$$

of the first hop, and configures or indicates that the offset of the frequency domain unit index of the second hop relative to the frequency domain unit index of the first hop is 2. The indexes of the frequency domain units activated for the terminal are 0, 1, 4, 5, and 6. The terminal determines, based on the frequency domain unit index

$${N}_{ID}^{1}$$

of the first hop and the offset 2, that the frequency domain unit index of unit index the second hop is 5 among the activated frequency domain units.

For example, the base station configures or indicates the frequency domain unit index

$${N}_{ID}^{2} = 3$$

of the second hop, and configures or indicates that an offset of a frequency domain unit index of a third hop relative to a frequency domain unit index of a previous hop is 2. The terminal determines, based on the frequency domain unit index

$${N}_{ID}^{2}$$

of the second hop and the offset 2, that the frequency domain unit index of the third hop is

$${N}_{ID}^{2} + 2 = 5.$$

For example, the base station configures or indicates the frequency domain unit index

$${N}_{ID}^{1} = 1$$

of the first hop, and the base station configures or indicates that an offset of a frequency domain unit index of each hop starting from the second hop relative to a frequency domain unit index of a previous hop is 2. The terminal first determines, based on the frequency domain unit index

$${N}_{ID}^{1}$$

of the first hop and the offset 2, that the frequency domain unit index is

$${N}_{ID}^{1} + 2 = 3$$

(with an offset count of 1). If a frequency domain unit with a frequency domain unit index 3 is available, the frequency domain unit index of the second hop is 3; if a frequency domain unit with a frequency domain unit index 3 is unavailable, the terminal offsets by 2 on the basis of the frequency domain unit index 3, and determines that the frequency domain unit index is

$${N}_{ID}^{1} + 2 * 2 = 5$$

(with an offset count of 2). If a frequency domain unit with a frequency domain unit index 5 is available, the frequency domain unit with the frequency domain unit index 5 is determined as the frequency domain unit index of the second hop; otherwise, the terminal keeps offsetting by 2 on the basis of frequency domain unit index 5 until an available frequency domain unit is found or the offset count reaches a maximum number. In this case, if the frequency domain unit with the frequency domain unit index 5 is available, the offset between the frequency domain unit index 5 of the second hop and the frequency domain unit index 1 of the first hop is 4.
(4) A first frequency domain unit offset list; where the first frequency domain unit offset list includes at least one second frequency domain unit offset, and the second frequency domain unit offset is used for indicating an offset of a frequency domain unit index of each hop starting from a second hop relative to a frequency domain unit index of a first hop, or an offset relative to a frequency domain unit index of a previous hop, or a minimum offset.

Specifically, the first frequency domain unit offset list may include at least one second frequency domain unit offset. For example, if the first transmission includes two hops, only one second frequency domain unit offset is needed to determine the frequency domain unit index of the second hop. If the first frequency domain unit offset list includes one second frequency domain unit offset, the terminal determines, based on the frequency domain unit index of the first hop and the second frequency domain unit offset, the frequency domain unit in which the second hop is located. Alternatively, if the first transmission includes two hops, and the first frequency domain unit offset list includes multiple second frequency domain unit offsets, the terminal determines, based on the frequency domain unit index of the first hop and the second frequency domain unit offset, candidate frequency domain units in which the second hop is located. For example, the terminal determines a first candidate frequency domain unit based on the frequency domain unit in which the first hop is located and a 1st second frequency domain unit offset in the first frequency domain unit offset list. If this frequency domain unit is available, this candidate frequency domain unit is determined as the frequency domain unit in which the second hop is located. If this candidate frequency domain unit is unavailable, the terminal determines a second candidate frequency domain unit based on the frequency domain unit in which the first hop is located and a 2nd second frequency domain unit offset in the frequency domain unit offset list, and based on whether the second candidate frequency domain unit is available, determines the frequency domain unit in which the second hop is located. If the second candidate frequency domain unit is unavailable, the terminal determines a third candidate frequency domain unit based on the frequency domain unit in which the first hop is located and a 3rd second frequency domain unit offset in the first frequency domain unit offset list. The process repeats until an available frequency domain unit is determined or until a last second frequency domain unit offset in the first frequency domain unit offset list is reached.

Optionally, assuming that a PUCCH/PUSCH has only two hops, one first frequency domain offset unit list configured by the base station includes multiple second frequency domain unit offsets, where each second frequency domain unit offset is used for indicating an offset of a frequency domain unit index of each hop starting from a second hop relative to a frequency domain unit index of a first hop. In this case, the multiple second frequency domain unit offsets configured in the first frequency domain offset unit list are candidate offsets, or the frequency domain units determined based on the multiple second frequency domain unit offsets are candidate frequency domain units. The terminal may use only one of the frequency domain units for transmission of the second hop. For example, the terminal uses a 1st available candidate frequency domain unit as the frequency domain unit in which the second hop is located.

Optionally, each second frequency domain unit offset in the first frequency domain unit offset list are in one-to-one correspondence with each hop starting from the second hop. For example, the 1st second frequency domain unit offset in the first frequency domain unit offset list corresponds to the second hop, and the 2nd second frequency domain unit offset in the first frequency domain unit offset list corresponds to the third hop.

Optionally, the indication of the frequency domain unit for the first hop and the indication of the first frequency domain unit offset list may be indicated separately and independently, and the indication manners may be the same or different. For example, the base station may configure one or more first frequency domain unit offset lists, and indicate one of the first frequency domain unit offset lists for the first transmission. The first frequency domain offset unit list is a first frequency domain unit offset list indicated by fourth information.
(5) At least one frequency domain unit pair; where the frequency domain unit pair is used for indicating a frequency domain unit associated with a frequency domain unit in which a first hop is located.

Specifically, the base station configures one or more frequency domain unit pairs (pair), where each frequency domain unit pair is used for indicating a frequency domain unit associated with the frequency domain unit in which the first hop is located.

For example, the first transmission includes two hops. The base station configures or indicates one frequency domain unit pair for the first transmission, where the frequency domain unit pair is used for indicating the frequency domain unit for the second hop associated with the frequency domain unit for the first hop. The terminal may determine, based on the frequency domain unit in which the first hop is located and the frequency domain unit pair, the frequency domain unit in which the second hop is located.

For example, the base station configures or indicates three frequency domain unit pairs for the first transmission, where a frequency domain unit pair 1 indicates a frequency domain unit for the second hop associated with the frequency domain unit for the first hop; a frequency domain unit pair 2 indicates a frequency domain unit for the third hop associated with the frequency domain unit for the first hop; and a frequency domain unit pair 3 indicates a frequency domain unit for the fourth hop associated with the frequency domain unit for the first hop. The terminal may determine, based on the frequency domain unit for the first hop and the three frequency domain unit pairs, the frequency domain unit for the second hop, the frequency domain unit for the third hop, and the frequency domain unit for the fourth hop.
(6) A first frequency domain unit list; where the first frequency domain unit list is used for indicating a frequency domain unit index of each hop starting from a second hop.

Specifically, the base station configures or indicates the frequency domain unit index N_{1D}¹ of the first hop for the first transmission, and the base station also configures or indicates one first frequency domain unit list for the first transmission; where the first frequency domain unit list includes multiple frequency domain unit indexes, and the frequency domain unit indexes in the first frequency domain unit list correspond to the frequency domain unit indexes of the hops starting from the second hop. For example, the first frequency domain unit list includes three frequency domain unit indexes, where a 1st frequency domain unit index corresponds to the frequency domain unit index of the second hop, a 2nd frequency domain unit index corresponds to the frequency domain unit index of the third hop, and a 3rd frequency domain unit index corresponds to the frequency domain unit index of the fourth hop.

Optionally, assuming that a PUCCH/PUSCH has only two hops, the multiple frequency domain unit indexes configured in the first frequency domain unit list are candidate frequency domain unit indexes, and the terminal may select one of them for transmission of the second hop. For example, the terminal uses a 1st available frequency domain unit as the frequency domain unit in which the second hop is located.
(7) A second frequency domain unit list; where the second frequency domain unit list is used for indicating a frequency domain unit index of each hop of the at least two hops.

Specifically, the base station configures or indicates one second frequency domain unit list for the first transmission, where the second frequency domain unit list includes multiple frequency domain unit indexes, and the frequency domain unit indexes in the second frequency domain unit list correspond to the frequency domain unit indexes of the hops. For example, the second frequency domain unit list includes four frequency domain unit indexes, where a 1st frequency domain unit index corresponds to the frequency domain unit index of the first hop, a 2nd frequency domain unit index corresponds to the frequency domain unit index of the second hop, a 3rd frequency domain unit index corresponds to the frequency domain unit index of the third hop, and a 4th frequency domain unit index corresponds to the frequency domain unit index of the fourth hop. The terminal may determine, based on the second frequency domain unit list, the frequency domain unit in which each hop is located.

Optionally, assuming that a PUCCH/PUSCH has only two hops, the multiple frequency domain unit indexes configured in the second frequency domain unit list are candidate frequency domain unit indexes, and the terminal may select two of them for transmission of the second hop. For example, the terminal uses a 1st available frequency domain unit in the candidate frequency domain units as a frequency domain unit for the first hop, and uses a 2nd available frequency domain unit in the candidate frequency domain units as a frequency domain unit for the second hop.
(8) A frequency hopping pattern, used for indicating the frequency domain unit in which each hop of the at least two hops is located.

Specifically, the frequency hopping pattern (pattern) indicates a frequency domain unit in which each hop of the first transmission is located, and the terminal may determine, based on the frequency hopping pattern, the frequency domain unit in which each hop is located.

Optionally, the frequency hopping pattern (pattern) further indicates time domain units for hops of the first transmission or a relationship between time domain units for different hops. For example, the pattern is indicated by an X-bit bitmap (bitmap), where each bit of the bitmap corresponds to one time unit, 1 indicates that the first transmission is performed in this time unit, and 0 indicates that the first transmission is not performed in this time unit. For example, 10010 indicates that the first hop and the second hop of the first transmission are transmitted in a first slot and a fourth slot, respectively. The first slot and the fourth slot may be a 1st slot and a 4th slot starting from a specific slot configured or indicated by the base station. In the prior art, the time domain unit in which the first hop of the first transmission is located is determined based on configuration or indication of the base station, and the time domain units in which the remaining hops are located are determined according to a predefined rule (for example, time domain units in which different hops are located are contiguous slots or sub-slots, or contiguous available slots or sub-slots, or the like). The frequency hopping pattern (pattern) further indicating time domain units for hops of the first transmission or a relationship between time domain units for different hops allows flexible indication of the time domain units for different hops, ensuring that each hop of the first transmission can be transmitted, and improving reliability of the first transmission.

Step 302: The terminal performs transmission on the frequency domain unit in which at least one hop of the at least two hops is located.

Specifically, after the terminal determines, based on the target information or the predefined rule, the frequency domain unit in which each hop of at least two hops of the first transmission is located, in a case that frequency hopping transmission of the first transmission is enabled, the terminal performs transmission on the frequency domain unit in which at least one hop of the at least two hops is located. The frequency hopping may be inter-slot frequency hopping, intra-slot frequency hopping, or inter-transmission occasion (such as inter-PUCCH or inter-PUSCH) frequency hopping.

Preferably, frequency domain hopping is inter-slot frequency hopping. For example, different hops of the first transmission are transmitted in different slots. In other words, within a same slot, the first transmission is performed on a same frequency domain unit.

It should be noted that in a case that a frequency domain unit for any one hop is unavailable (for example, the frequency domain unit is deactivated or in a deactivated state, or a frequency domain bandwidth of the first transmission exceeds a frequency domain range of the frequency domain unit, or a transmission direction of the first transmission does not match a transmission direction configured or indicated for the frequency domain unit, for example, the first transmission is uplink transmission, and any one symbol position corresponding to the frequency domain unit is configured or indicated as a downlink (DL) symbol), the terminal may not perform transmission on this frequency domain unit. For example, if the first transmission includes two hops, the frequency domain unit in which the first hop is located is available, and the frequency domain unit in which the second hop is located is unavailable, the terminal cancels the first transmission; or the terminal cancels transmission of the second hop; or the terminal cancels frequency-domain frequency hopping transmission, performs transmission of the first hop and the second hop on the frequency domain unit in which the first hop is located, and does not perform transmission on the frequency domain unit in which the second hop is located; or based on the predefined rule and/or indication of the base station, the terminal switches the second hop to another available frequency domain unit for transmission or delays the transmission to another available time unit.

Optionally, the frequency domain unit being available includes at least one of the following: the frequency domain unit being activated or in an activated state; a transmission direction configured or indicated for a time domain position corresponding to the frequency domain unit being the same as that of the first transmission; for example, in a case that the first transmission is uplink transmission, the time domain position corresponding to the frequency domain unit is configured or indicated as a UL, flexible, or subband full duplex (SBFD) symbol; in a case that the first transmission is downlink transmission, the time domain position corresponding to the frequency domain unit is configured or indicated as a DL, flexible, or SBFD symbol; and a frequency domain resource for the first transmission being within an available resource range of the frequency domain unit.

Optionally, a frequency hopping manner of the first transmission is intra-slot frequency hopping, inter-slot frequency hopping, or inter-transmission occasion frequency hopping (inter-transmission occasion, such as inter-PUCCH or inter-PUSCH).

In the embodiments of this application, the terminal determines, based on target information or a predefined rule, a frequency domain unit in which each hop of at least two hops of first transmission is located; where the target information is used for indicating a frequency domain unit in which at least one hop of the at least two hops is located; the predefined rule is used for determining the frequency domain unit in which at least one hop of the at least two hops is located; and the first transmission supports frequency hopping transmission on different frequency domain units. This allows the terminal to perform transmission on the frequency domain unit in which at least one hop of the at least two hops is located, thereby implementing frequency hopping transmission of the first transmission between different frequency domain units. As a result, relatively high frequency diversity gain can be obtained, and performance of the communication system can be improved.

Optionally, a manner of acquiring the frequency domain unit index of the first hop is the same as or different from a manner of acquiring the frequency domain unit index of each hop starting from the second hop.

Specifically, the base station configures the frequency domain unit index of the first hop through higher layer signaling, and indicates the frequency domain unit index of the second hop through dynamic indication signaling; or the base station indicates the frequency domain unit index of the first hop through dynamic indication signaling, and configures the frequency domain unit index of the first hop through higher layer signaling.

In the embodiments of this application, the terminal can accurately determine, based on the target information configured or indicated by the base station, the frequency domain unit in which each hop of at least two hops of the first transmission is located. This allowing the terminal to perform transmission on different frequency domain units in which at least one hop of the at least two hops is located, thereby obtaining relatively high frequency diversity gain or enhancing anti-interference capability of uplink transmission, and improving performance of the communication system.

Optionally, the terminal determines a frequency domain unit index of an h-th hop based on the frequency domain unit index of the first hop and the first frequency domain unit offset; where h is an integer greater than 1; or the terminal determines a frequency domain unit index of an (m+1)-th hop based on a frequency domain unit index of an m-th hop and the first frequency domain unit offset; where m is an integer greater than 0.

Specifically, in a case that the target information includes second information and the first frequency domain unit offset, the terminal may determine a frequency domain unit index of an h-th hop based on the frequency domain unit index of the first hop indicated by the second information and the first frequency domain unit offset, where h is an integer greater than 1. For example, when h is 2, the frequency domain unit index of the first hop is 1, the first frequency domain unit offset is 2, and the terminal may determine that the frequency domain unit index of the second hop is 3; when his 3, the terminal may determine that the frequency domain unit index of the third hop is 5.

Alternatively, the terminal may determine a frequency domain unit index of an (m+1)-th hop based on a frequency domain unit index of an m-th hop and the first frequency domain unit offset; where m is an integer greater than 0. For example, when m is 1, the frequency domain unit index of the m-th hop is 1, and the first frequency domain unit offset is 2, the frequency domain unit index is determined to be 3. However, since a frequency domain unit with the index 3 is unavailable, the terminal offsets by 2 on the basis of the frequency domain unit index 3, and determines that the frequency domain unit index is 5. A frequency domain unit with the frequency domain unit index 5 is available, so the frequency domain unit index of the second hop is 5.

In the embodiments of this application, the terminal determines the frequency domain unit index of the h-th hop through the frequency domain unit index of the first hop and the first frequency domain unit offset; where h is an integer greater than 1; or the terminal determines the frequency domain unit index of the (m+1)-th hop based on the frequency domain unit index of the m-th hop and the first frequency domain unit offset; where m is an integer greater than 0. This allows the terminal to perform frequency hopping transmission between different frequency domain units, thereby obtaining sufficient frequency diversity gain or enhancing anti-interference capability, and improving effectiveness and performance of the communication system.

Optionally, the determining, by the terminal, a frequency domain unit index of an (m+1)-th hop based on a frequency domain unit index of an m-th hop and the first frequency domain unit offset includes:
determining, by the terminal, the frequency domain unit index of the (m+1)-th hop to be (Nₘ+offset1*n) based on the frequency domain unit index Nₘ of the m-th hop and the first frequency domain unit offset offset1; where n satisfies at least one of the following: n is a smallest positive integer for which the frequency domain unit with the frequency domain unit index (Nₘ+offset1*n) is available; n is less than or equal to a first value; or n is a predefined integer.

For example, when m is 1, the frequency domain unit index Nₘ of the m-th hop is 1, and the first frequency domain unit offset offset1 is 2, the frequency domain unit index determined by the 1st offset of the terminal is 1+2*1=3. However, since the frequency domain unit with the index 3 is unavailable, the terminal offsets by 2 on the basis of the frequency domain unit index 3, and the frequency domain unit index determined by the 2nd offset is 1+2*2=5. In a case that the frequency domain unit with the index 5 is unavailable, the terminal offsets by 2 on the basis of the frequency domain unit index 5, and the frequency domain unit index determined by the 3rd offset is 1+2*3=7. In a case that the frequency domain unit with the index 7 is unavailable, the offsetting is repeated until an available frequency domain unit is found or until the maximum number of offsets predefined or configured by the base station is performed.

Optionally, if an index of a frequency domain unit of an (m−1)-th hop is Nₘ₋₁, the terminal may determine a frequency domain unit index of an m-th hop to be (Nₘ₋₁+offset1*n) based on the frequency domain unit index Nₘ₋₁ of the (m−1)-th hop and the first frequency domain unit offset offset1; where n satisfies at least one of the following: n is a smallest positive integer for which the frequency domain unit with the frequency domain unit index (Nₘ₋₁+offset1*n) is available; n is less than or equal to a first value; or n is a predefined integer.

Optionally, the terminal determines a frequency domain unit index of an (i+1)-th hop based on the frequency domain unit index of the first hop and an i-th second frequency domain unit offset in the first frequency domain unit offset list; where i is a positive integer; or
the terminal determines a frequency domain unit index of an (i+1)-th hop based on the frequency domain unit index N₁ of the first hop and a j-th second frequency domain unit offset offsetⱼ in the first frequency domain unit offset list; where j is greater than or equal to i and is a smallest positive integer for which a frequency domain unit with a frequency domain unit index (N₁+offsetⱼ) is available; or
the terminal determines a frequency domain unit index of a (g+1)-th hop based on a frequency domain unit index of a g-th hop and a g-th second frequency domain unit offset in the first frequency domain unit offset list; where g is an integer greater than 0; or
the terminal determines a frequency domain unit index of a (g+1)-th hop to be N_{g}+offsetₓ based on a frequency domain unit index N_{g} of a g-th hop and an x-th second frequency domain unit offset offsetₓ in the first frequency domain unit offset list; where g is an integer greater than 1, and x is greater than or equal to g and is a smallest positive integer for which a frequency domain unit with the frequency domain unit index (N_{g}+offsetₓ) is available; or
the terminal determines a frequency domain unit index of a (q+1)-th hop to be

$${N}_{q} + {\sum }_{j = k}^{j = k + p} {offset}_{j}$$

based on a frequency domain unit index N_{q} of a q-th hop and a k-th second frequency domain unit offset and p second frequency domain unit offsets after the k-th second frequency domain unit offset in the first frequency domain unit offset list, where p is a smallest positive integer for which a frequency domain unit with the frequency domain unit index

$${N}_{q} + {\sum }_{j = k}^{j = k + p} {offset}_{j}$$

is available, q is an integer greater than or equal to 1, offsetⱼ represents a j-th second frequency domain unit offset in the first frequency domain unit offset list, and k−1 is an index of a second frequency domain unit offset used for determining a (q−1)-th hop in the first frequency domain offset list.

Specifically, the first frequency domain unit offset list includes at least one second frequency domain unit offset, and each second frequency domain unit offset is in one-to-one correspondence with each hop starting from the second hop.

In a case that the target information includes second information and the first frequency domain unit offset list, the terminal may determine the frequency domain unit index of the (i+1)-th hop based on the frequency domain unit index of the first hop indicated by the second information and the i-th second frequency domain unit offset in the first frequency domain unit offset list; where i is a positive integer. For example, if i=1, the frequency domain unit index of the first hop is 1, the 1st second frequency domain unit offset in the first frequency domain unit offset list is 2, and the second frequency domain unit offset represents an offset relative to the frequency domain unit index of the first hop, the terminal may determine that the frequency domain unit index of the second hop is 3. If i=2, the frequency domain unit index of the first hop is 1, and the 2nd second frequency domain unit offset in the first frequency domain unit offset list is 3, the terminal may determine that the frequency domain unit index of the third hop is 4.

Alternatively, the terminal may determine the frequency domain unit index of the (i+1)-th hop based on the frequency domain unit index N₁ of the first hop and the j-th second frequency domain unit offset offsetⱼ in the first frequency domain unit offset list; where j is greater than or equal to i and is a smallest positive integer for which a frequency domain unit with the frequency domain unit index N₁+offsetⱼ is available. For example, if i=1, the frequency domain unit index N₁ of the first hop is 1, the second frequency domain unit offset represents an offset relative to the frequency domain unit index of the first hop, and the j-th (j=1) second frequency domain unit offset offset₁ in the first frequency domain unit offset list is 2, the determined frequency domain unit index is 1+2-3. In a case that a frequency domain unit with the index 3 is available, the frequency domain unit index 3 is determined as the frequency domain unit index of the second hop; or
in a case that the frequency domain unit with the index 3 is unavailable, and the j-th (j=2) second frequency domain unit offset offset₂ in the frequency domain unit offset list is 5, the determined frequency domain unit index is 1+5=6. In a case that a frequency domain unit with the index 6 is unavailable, the process repeats by taking the j-th second frequency domain unit offset offsetⱼ in the first frequency domain unit list, until a determined frequency domain unit is available or the last second frequency domain unit offset in the first frequency domain offset unit list is executed.

Alternatively, the terminal may determine the frequency domain unit index of the (g+1)-th hop based on the frequency domain unit index of the g-th hop and the g-th second frequency domain unit offset in the first frequency domain unit offset list; where g is an integer greater than 0. For example, if g=1, the first second frequency domain unit offset in the first frequency domain unit offset list is 2, and the second frequency domain unit offset represents an offset relative to a frequency domain unit index of a previous hop, the determined frequency domain unit index is 1+2=3. In a case that the frequency domain unit with the index 3 is available, the frequency domain unit index of the second hop is determined to be 3.

Alternatively, the terminal may determine the frequency domain unit index of the (g+1)-th hop to be N_{g}+offset, based on the frequency domain unit index N_{g} of the g-th hop and the x-th second frequency domain unit offset offsetₓ in the first frequency domain unit offset list; where g is an integer greater than 0, and x is greater than or equal to g and is a smallest positive integer for which the frequency domain unit with the frequency domain unit index (N_{g}+offsetₓ) is available. For example, if g=1, X=2, the frequency domain unit index of the first hop is located is 1, the 2nd second frequency domain unit offset in the first frequency domain unit offset list is 3, and the second frequency domain unit offset represents an offset relative to a frequency domain unit index of a previous hop, the frequency domain unit index is determined to be 4 based on the first second frequency domain unit offset in the first frequency domain unit offset list. A frequency domain unit with the index 4 is available, then the frequency domain unit index of the second hop is determined to be 4.

Alternatively, the terminal may determine the frequency domain unit index of the (q+1)-th hop to be

$${N}_{q} + {\sum }_{j = k}^{j = k + p} {offset}_{j}$$

based on the frequency domain unit index N_{q} of the q-th hop and the k-th second frequency domain unit offset and p second frequency domain unit offsets after the k-th second frequency domain unit offset in the first frequency domain unit offset list, where p is a smallest positive integer for which a frequency domain unit with the frequency domain unit index

$${N}_{q} + {\sum }_{j = k}^{j = k + p} {offset}_{j}$$

is available, q is an integer greater than or equal to 0, offsetⱼ represents a j-th second frequency domain unit offset in the first frequency domain unit offset list, and k−1 is an index of a second frequency domain unit offset used for determining a (q−1)-th hop in the frequency domain offset list. It is assumed that the index of the second frequency domain unit offset corresponding to the first hop in the first frequency domain offset list is 0, q=1, p=3, k=1, the second frequency domain unit offset represents an offset relative to a frequency domain unit index of a previous hop, the frequency domain unit index N₁ of the first hop is 1, the 1st second frequency domain unit offset is 2, the 2nd second frequency domain unit offset is 3, the 3rd second frequency domain unit offset is 4, and the 4th second frequency domain unit offset is 2. Then the frequency domain unit index of the second hop is 1+2+3+4+2=12. Alternatively, if the frequency domain unit index N₁ of the first hop is 1, the 1st second frequency domain unit offset is 2, the 2nd second frequency domain unit offset is 3, the 3rd second frequency domain unit offset is 4, and the 4th second frequency domain unit offset is 2, the frequency domain unit index determined based on the frequency domain unit index of the first hop and the 1st second frequency domain unit offset is 3. A frequency domain unit with the index 3 is unavailable, then the terminal offsets by the 2nd second frequency domain unit offset on the basis of the index 3, to determine that the frequency domain unit index is 6. A frequency domain unit with the index 6 is unavailable, then the terminal offsets by the 3rd second frequency domain unit offset on the basis of the index 6, to determine that the frequency domain unit index is 10. A frequency domain unit with the index 10 is available, then the terminal determines that the frequency domain unit index of the second hop is 10.

In the embodiments of this application, the terminal determines the frequency domain unit index of each hop after the second hop based on the frequency domain unit index of the first hop and the second frequency domain unit offset in the first frequency domain unit offset list. This allows the terminal to perform frequency hopping transmission between different frequency domain units, thereby obtaining sufficient frequency diversity gain or enhancing anti-interference capability, and improving effectiveness and performance of the communication system.

Optionally, in a case that the frequency domain unit index obtained based on the first frequency domain unit offset or the second frequency domain unit offset is greater than a maximum frequency domain unit index in configured or activated frequency domain units, the terminal determines, by using a wrap-around or modulo operation, the frequency domain unit index of each hop starting from the second hop.

Specifically, in a case that the frequency domain unit index obtained based on the first frequency domain unit offset or the second frequency domain unit offset is greater than a maximum frequency domain unit index in configured or activated frequency domain units, the terminal may determine, by using a wrap-around or modulo operation, the frequency domain unit index of each hop starting from the second hop. For example, in a case that

$${N}_{ID}^{2} = {N}_{ID}^{1} + offset$$

exceeds a maximum index of UL available or activated frequency domain units, the terminal uses a wrap-around operation to determine

$${N}_{ID}^{2} , such as {N}_{ID}^{2} = mod ( {N}_{ID}^{1} + offset , {N}_{ID}^{total} ) , where {N}_{ID}^{total}$$

represents the number of uplink configured or available or activated frequency domain units.

Optionally, in a case that the target information includes the at least one frequency domain unit pair, the determining, by a terminal based on target information, a frequency domain unit in which each hop of at least two hops of a first transmission is located includes:
determining, by the terminal based on each of the at least one frequency domain unit pair, the frequency domain unit index of each hop starting from the second hop; and determining, by the terminal based on the frequency domain unit index of the first hop and the frequency domain unit index of each hop starting from the second hop, the frequency domain unit in which each hop of the at least two hops of the first transmission is located.

Specifically, since each frequency domain unit pair is used for indicating a frequency domain unit associated with the frequency domain unit for the first hop, the terminal may determine, based on each frequency domain unit pair, a frequency domain unit index of each hop starting from the second hop, that is, using the frequency domain unit index associated with the frequency domain unit for the first hop as the frequency domain unit index of each hop starting from the second hop. The terminal may determine, based on the frequency domain unit index of the first hop and the frequency domain unit index of each hop starting from the second hop, the frequency domain unit in which each hop of the at least two hops of the first transmission is located.

For example, the base station configures or indicates three frequency domain unit pairs for the first transmission, where a frequency domain unit pair 1 indicates a frequency domain unit for the second hop associated with the frequency domain unit for the first hop; a frequency domain unit pair 2 indicates a frequency domain unit for the third hop associated with the frequency domain unit for the first hop; and a frequency domain unit pair 3 indicates a frequency domain unit for the fourth hop associated with the frequency domain unit for the first hop. The terminal may determine the frequency domain unit for the second hop, the frequency domain unit for the third hop, and the frequency domain unit for the fourth hop based on the frequency domain unit for the first hop and the three frequency domain unit pairs, thereby determining the frequency domain unit for the first hop, the frequency domain unit for the second hop, the frequency domain unit for the third hop, and the frequency domain unit for the fourth hop.

In the embodiments of this application, the terminal determines the frequency domain unit index of each hop based on each frequency domain unit pair. This allows the terminal to perform frequency hopping transmission between different frequency domain units, thereby obtaining relatively high frequency diversity gain or enhancing anti-interference capability, and improving effectiveness and performance of the communication system.

Optionally, in a case that the target information includes the first frequency domain unit list, the determining, by a terminal based on target information, a frequency domain unit in which at least one of at least two hops of the first transmission is located includes:
determining, by the terminal based on the first frequency domain unit list and according to an order of frequency domain unit indexes in the first frequency domain unit list corresponding sequentially to the frequency domain unit index of each hop starting from the second hop, the frequency domain unit index of each hop starting from the second hop; and determining, by the terminal based on the frequency domain unit index of the first hop and the frequency domain unit index of each hop starting from the second hop, the frequency domain unit in which at least one hop of the at least two hops of the first transmission is located.

Specifically, the first frequency domain unit list includes multiple frequency domain unit indexes, and the frequency domain unit indexes in the first frequency domain unit list correspond respectively to the frequency domain unit indexes of the hops starting from the second hop. The terminal may determine, based on the first frequency domain unit list and according to the order of the frequency domain unit indexes in the first frequency domain unit list corresponding sequentially to the frequency domain unit indexes of the hops starting from the second hop, the frequency domain unit indexes of the hops starting from the second hop. The terminal then determines, based on the frequency domain unit index of the first hop and the frequency domain unit indexes of the hops starting from the second hop, the frequency domain unit in which each hop of the at least two hops is located.

For example, the first frequency domain unit list includes three frequency domain unit indexes, where a 1st frequency domain unit index corresponds to the frequency domain unit index of the second hop, a 2nd frequency domain unit index corresponds to the frequency domain unit index of the third hop, and a 3rd frequency domain unit index corresponds to the frequency domain unit index of the fourth hop. The terminal may determine, based on the first frequency domain unit list and according to the order of the frequency domain unit indexes in the first frequency domain unit list corresponding sequentially to the frequency domain unit indexes of the hops starting from the second hop, that the frequency domain unit index of the second hop is the 1st frequency domain unit index, the frequency domain unit index of the third hop is the 2nd frequency domain unit index, and the frequency domain unit index of the fourth hop is the 3rd frequency domain unit index.

Optionally, the determining, by the terminal based on the first frequency domain unit list and according to an order of frequency domain unit indexes in the first frequency domain unit list corresponding sequentially to the frequency domain unit index of each hop starting from the second hop, the frequency domain unit index of at least one hop starting from the second hop includes:
in a case that a first target frequency domain unit determined by the terminal according to the order of the frequency domain unit indexes in the first frequency domain unit list corresponding sequentially to the frequency domain unit index of each hop starting from the second hop is unavailable, sequentially proceeding, by the terminal, to a next frequency domain unit of the first target frequency domain unit until a determined frequency domain unit is available or until a last frequency domain unit in the first frequency domain unit list is reached.

Specifically, the first target frequency domain unit is an unavailable frequency domain unit in the first frequency domain unit list. In a case that the first target frequency domain unit determined by the terminal according to the order of the frequency domain unit indexes in the first frequency domain unit list corresponding sequentially to the frequency domain unit index of each hop starting from the second hop is unavailable, the terminal may sequentially proceed to a next frequency domain unit of the first target frequency domain unit. In a case that the next frequency domain unit of the first target frequency domain unit is unavailable, the next frequency domain unit is used as the first target frequency domain unit, and then the terminal proceeds to a next frequency domain unit of the first target frequency domain unit. Such process repeats until a determined frequency domain unit is available or until the last frequency domain unit in the first frequency domain unit list is reached.

Alternatively, the terminal determines corresponding candidate frequency domain units based on the first frequency domain unit list, and selects, from the candidate frequency domain units, the first N available frequency domain units for transmission of the second hop, the third hop, . . . , the (N+1)-th hop of the first transmission respectively.

For example, the first frequency domain unit list includes three frequency domain unit indexes. In a case that a frequency domain unit corresponding to a 1st frequency domain unit index is available, the terminal determines the 1st frequency domain unit index as the frequency domain unit index of the second hop. In a case that the frequency domain unit corresponding to the 1st frequency domain unit index is unavailable, the terminal determines whether a frequency domain unit corresponding to a 2nd frequency domain unit index is available; and in a case that the frequency domain unit corresponding to the 2nd frequency domain unit index is available, the terminal determines the 2nd frequency domain unit index as the frequency domain unit index of the second hop.

In the embodiments of this application, the terminal determines the frequency domain unit index of each hop based on the first frequency domain unit list. This allows the terminal to perform frequency hopping transmission between different frequency domain units, thereby obtaining relatively high frequency diversity gain or enhancing anti-interference capability, and improving effectiveness and performance of the communication system.

Optionally, in a case that the target information includes the second frequency domain unit list, determining, by a terminal based on target information, a frequency domain unit in which at least one of at least two hops of a first transmission is located includes:
determining, by the terminal based on the second frequency domain unit list and according to an order of frequency domain unit indexes in the second frequency domain unit list, the frequency domain unit in which each hop of the at least two hops of the first transmission is located;
or
in a case that a second target frequency domain unit determined based on an order of frequency domain unit indexes in the second frequency domain unit list is unavailable, sequentially proceeding, by the terminal, to a next frequency domain unit of the second target frequency domain unit until a determined frequency domain unit is available or until a last frequency domain unit in the second frequency domain unit list is reached.

Specifically, the second frequency domain unit list includes multiple frequency domain unit indexes, and each frequency domain unit index in the second frequency domain unit list corresponds to the frequency domain unit index of each hop. For example, the second frequency domain unit list includes three frequency domain unit indexes, where a 1st frequency domain unit index corresponds to the frequency domain unit index of the first hop, a 2nd frequency domain unit index corresponds to the frequency domain unit index of the second hop, and a 3rd frequency domain unit index corresponds to the frequency domain unit index of the third hop. The terminal may determine, based on the second frequency domain unit list, the frequency domain unit in which each hop is located.

The terminal may determine, based on the order of the frequency domain unit indexes in the second frequency domain unit list, the frequency domain unit in which each hop of the at least two hops of the first transmission is located. For example, the terminal determines that a 1st frequency domain unit index is the frequency domain unit index of the first hop, a 2nd frequency domain unit index is the frequency domain unit index of the second hop, and a 3rd frequency domain unit index is the frequency domain unit index of the third hop.

Alternatively, the second target frequency domain unit is an unavailable frequency domain unit in the second frequency domain unit list. In a case that the second target frequency domain unit determined by the terminal based on the order of the frequency domain unit indexes in the second frequency domain unit list is unavailable, the terminal may sequentially proceed to a next frequency domain unit of the second target frequency domain unit, and in a case that the next frequency domain unit of the second target frequency domain unit is unavailable, use the next frequency domain unit as the second target frequency domain unit, and then proceed to a next frequency domain unit of the second target frequency domain unit. Such process repeats until a determined frequency domain unit is available or until the last frequency domain unit in the second frequency domain unit list is reached.

For example, the second frequency domain unit list includes four frequency domain unit indexes. In a case that a frequency domain unit corresponding to a 1st frequency domain unit index is available, the terminal determines the 1st frequency domain unit index as the frequency domain unit index of the first hop. In a case that the frequency domain unit corresponding to the 1st frequency domain unit index is unavailable, the terminal determines whether a frequency domain unit corresponding to a 2nd frequency domain unit index is available; and in a case that the frequency domain unit corresponding to the 2nd frequency domain unit index is available, the terminal determines the 2nd frequency domain unit index as the frequency domain unit index of the first hop. In a case that a frequency domain unit corresponding to a 3rd frequency domain unit index is available, the terminal determines the 3rd frequency domain unit index as the frequency domain unit index of the second hop.

Alternatively, the terminal determines corresponding candidate frequency domain units based on the second frequency domain unit list, and selects, from the candidate frequency domain units, the first M available frequency domain units for transmission of the first hop, the second hop, . . . , the M-th hop of the first transmission respectively.

In the embodiments of this application, the terminal determines the frequency domain unit index of each hop based on the second frequency domain unit list. This allows the terminal to perform frequency hopping transmission between different frequency domain units, thereby obtaining relatively high frequency diversity gain or enhancing anti-interference capability, and improving effectiveness and performance of the communication system.

Optionally, in a case that any one frequency domain unit determined by the terminal based on the target information is unavailable, performing, by the terminal, transmission based on any one of the following: canceling, by the terminal, transmission of a hop corresponding to the any one frequency domain unit of the first transmission; switching, by the terminal, transmission of a hop corresponding to the any one frequency domain unit of the first transmission to another available frequency domain unit for transmission; and delaying, by the terminal, transmission of a hop corresponding to the any one frequency domain unit of the first transmission to an available frequency domain unit corresponding to another available time unit for transmission.

Specifically, in a case that any one frequency domain unit determined by the terminal based on the target information is unavailable, the terminal may cancel transmission of the hop corresponding to the any one frequency domain unit of the first transmission, or the terminal may switch transmission of the hop corresponding to the any one frequency domain unit of the first transmission to another available frequency domain unit for transmission according to a predefined rule and/or indication of the base station, or the terminal delays transmission of the hop corresponding to the first frequency domain unit of the first transmission to an available frequency domain unit corresponding to another available time unit for transmission.

Optionally, in a case that only one of the at least two hops of the first transmission has an available frequency domain unit or the number of available frequency domain units is less than the first value, falling back, by the terminal, from a frequency hopping mode to a non-frequency hopping mode or a non-inter-frequency domain unit frequency hopping mode.

Optionally, the first value is determined based on at least one of the following: the maximum number of frequency hops; network indication; or protocol predefinition.

For example, if the first transmission includes two hops, a frequency domain unit in which a first hop is located is available, and a frequency domain unit in which a second hop is located is unavailable, the terminal may fall back from a frequency hopping mode to a non-frequency hopping mode or a non-inter-frequency domain unit frequency hopping mode. Alternatively, if the first transmission includes three hops, the maximum number of frequency hops configured or indicated by the base station is 3, frequency domain units in which a first hop and a second hop are located are available, and a frequency domain unit in which a third hop is located is unavailable, the terminal may fall back from a frequency hopping mode to a non-frequency hopping mode or a non-inter-frequency domain unit frequency hopping mode.

Next, the following further describes the frequency hopping transmission method according to the embodiments of this application through specific embodiments.

### Embodiment 1

It is assumed that one cell consists of three frequency domain units, and sizes of these three frequency domain units (a frequency domain unit index 0, a frequency domain unit index 1, and a frequency domain unit index 2) are 5 MHz, 10 MHz, and 5 MHz. A base station may configure some or all frequency domain units for uplink transmission, and the base station may also activate or deactivate these three frequency domain units. It should be noted that in FIG. 4 to FIG. 8, the frequency domain unit being a BWP is used as an example for description. The frequency domain unit may be any one of a bandwidth (band), a carrier, a subband, and a BWP.

For each PUCCH resource, the base station configures (for example, configures a frequency domain unit in which the PUCCH resource is located, or configures a frequency domain unit corresponding to the PUCCH resource per PUCCH resource, or for channel state information (CSI), scheduling request (SR), or semi-persistent scheduling (SPS) hybrid automatic repeat request acknowledgement (HARQ-ACK) reporting, indicates a frequency domain unit for the CSI, SR, SPS, or HARQ-ACK reporting) or indicates (for example, for a dynamically scheduled HARQ-ACK, indicates a frequency domain unit for the HARQ-ACK through scheduling or activation DCI) a frequency domain unit index of a first hop (the frequency domain unit index may be an ID), and configures or indicates a frequency domain unit index of a second hop. For example, the PUCCH resource is configured in the following manners.
Manner 1: The base station configures, through a higher layer parameter, a frequency domain unit index of each hop of each PUCCH transmission. FIG. 4 is a first schematic diagram of a frequency domain unit index of each hop of PUCCH transmission according to an embodiment of this application. As shown in FIG. 4, the base station configures, through a higher layer parameter, that a first hop of a PUCCH resource is in BWP0 (in this embodiment, assuming that the frequency domain unit is BWP0) and a second hop is in BWP1. For example, when configuring each PUCCH resource (assuming that an IE PUCCH resource is used), the base station configures the frequency domain unit ID of each hop. As shown below, BWP0 indicates the BWP ID of the first hop of the PUCCH resource, and BWP1 indicates the BWP ID of the second hop of the PUCCH resource.

```
  PUCCH resource{
  PUCCH-resourceId
  BWP0 → that is, provide a BWP ID for the first hop of the PUCCH
  resource
(provide a BWP ID for the first hop of the PUCCH resource)
  StartingPRB
  Frequency hopping (intra-slot, inter-slot, other?) →
  BWP1 Optionally, when inter-slot frequency hopping is enabled,
  configure
BWP1 (Cond on inter-slot frequency hopping)
  SecondHopPRB
  }
```

Manner 2: The base station configures or indicates a frequency hopping offset for PUCCH transmission. In one implementation, the base station indicates (for example, through higher layer configuration or DCI indication) one frequency hopping offset; in another implementation, the base station indicates (for example, through higher layer configuration or DCI indication) one frequency domain unit offset list. For example, the terminal determines, through base station indication, higher layer configuration, or a predefined rule, the frequency domain unit for the first hop of the PUCCH transmission, and determines, based on the frequency hopping offset, the frequency domain unit for each hop starting from the second hop. The frequency hopping offset (offset) may be an offset relative to the frequency domain unit index of the first hop, or an offset relative to a frequency domain unit index of a previous hop, or the number of available or activated frequency domain units to be offset among the available or activated frequency domain units relative to a frequency domain unit index of a previous hop.

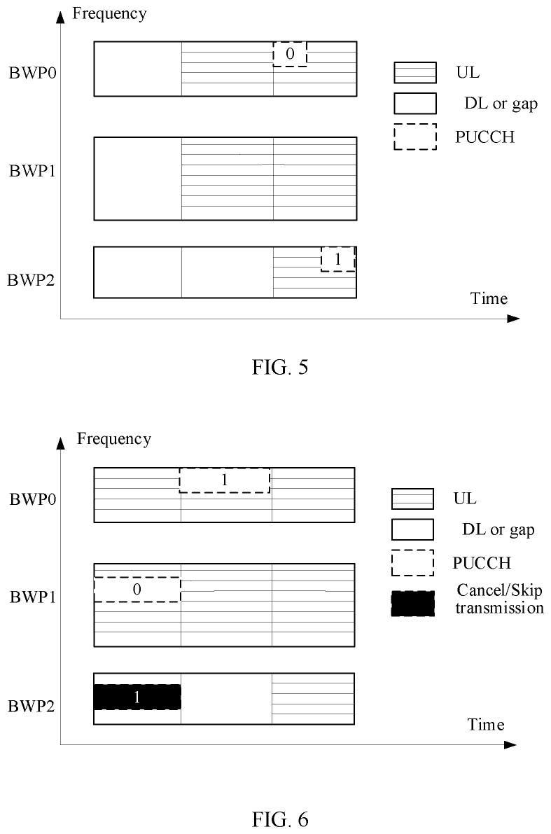

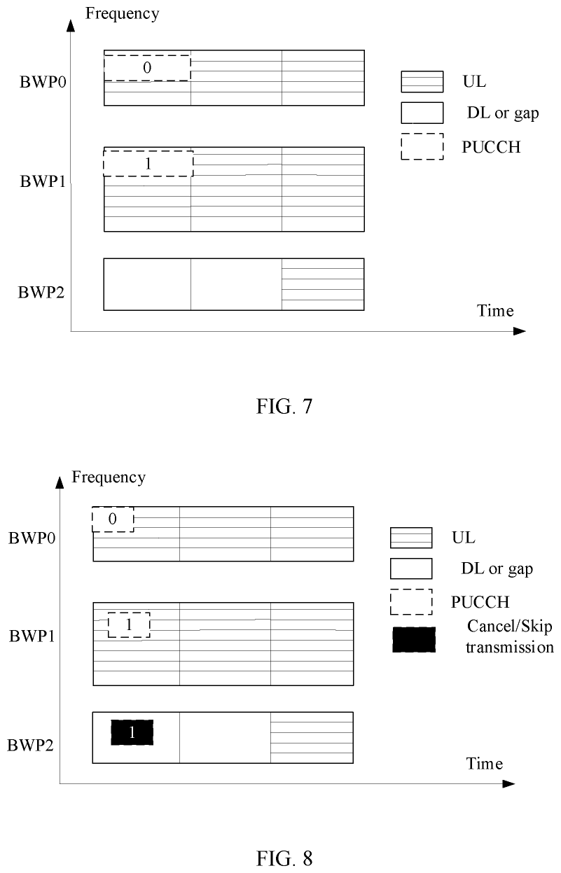

FIG. 5 is a second schematic diagram of a frequency domain unit index of each hop of PUCCH transmission according to an embodiment of this application. As shown in FIG. 5, the base station determines, through higher layer parameter configuration, DCI indication, or a predefined rule, that the frequency domain unit in which the first hop of the PUCCH transmission is located is BWP0, and that the frequency hopping offset is 2. Then the terminal may determine that the frequency domain unit in which the second hop is located is BWP2. FIG. 6 is a third schematic diagram of a frequency domain unit index of each hop of PUCCH transmission according to an embodiment of this application. As shown in FIG. 6, the base station determines, through higher layer parameter configuration, DCI indication, or a predefined rule, that the frequency domain unit in which the first hop of the PUCCH transmission is located is BWP1, and that the frequency hopping offset is 1. Then the terminal may determine that the frequency domain unit is BWP2. Since BWP2 is unavailable, the terminal may continue to offset by 1 frequency domain unit, thereby determining BWP0. In a case that the corresponding resource on BWP0 is available, the terminal determines that the frequency domain unit in which the second hop is located is BWP0.
Manner 3: The base station configures at least one frequency domain unit pair (pair) or frequency domain unit list (list), and configures or indicates one frequency domain unit pair or frequency domain unit list (list) for each PUCCH resource. FIG. 7 is a fourth schematic diagram of a frequency domain unit index of each hop of PUCCH transmission according to an embodiment of this application. As shown in FIG. 7, the base station configures one frequency domain unit pair for one PUCCH through higher layer configuration signaling, and the terminal determines, based on the frequency domain unit pair, that the frequency domain unit in which the first hop of the PUCCH transmission is located is BWP0 and the frequency domain unit in which the second hop is located is BWP1.

For example, the base station configures one frequency domain unit pair (pair) in the following manner, where each frequency domain unit pair (pair) may be identified by a frequency domain unit pair (pair) ID (BWP-pairId), and each frequency domain unit pair (pair) may be configured with two frequency domain unit indexes.

BWP pair{
BWP-pairId
BWPID1
BWPID2
}

For example, when configuring each PUCCH resource, the base station configures a corresponding frequency domain unit pair (pair) for the PUCCH resource. In addition, the base station may also indicate, through dynamic signaling, a corresponding BWP-pairId for each PUCCH resource.

```
  PUCCH resource{
  PUCCH-resourceId
  BWP-pairId
  StartingPRB
  Frequency hopping (intra-slot, inter-slot)//used to configure the
frequency hopping mode. Optionally, the frequency hopping mode
includes at least one of the following: intra-slot frequency hopping,
inter-slot frequency hopping, or inter- transmission occasion frequency
hopping.
  SecondHopPRB // Since BWP1 is paired with BWP2, the second hop is
within BWP2
  }
```

Or

For example, the base station configures one frequency domain unit list (list) in the following manner, where each frequency domain unit list (list) may be identified by a frequency domain unit list (list ID) ID (such as a parameter BWP-listId), and each frequency domain unit list (list) may configure multiple frequency domain unit indexes.

BWP list{
BWP-listId
BWP ID1
BWPID2
BWPID3
...
}

For example, when configuring each PUCCH resource, the base station configures a corresponding frequency domain unit list for the PUCCH resource. The base station may also indicate, through dynamic signaling, a corresponding BWP-listId for each PUCCH resource.

```
  PUCCH resource{
  PUCCH-resourceId
  BWP-listId
  StartingPRB
  Frequency hopping (intra-slot, inter-slot)//used to configure the
frequency hopping mode. Optionally, the frequency hopping mode
includes at least one of the following: intra-slot frequency hopping,
inter-slot frequency hopping, or inter- transmission occasion frequency
hopping.
  }
```

### Embodiment 2

In the prior art, physical downlink shared channel (PDSCH) transmission supports allocation of non-contiguous physical resource blocks (PRB) within one BWP, so frequency domain frequency hopping is not required. For sub-3G spectrum resources that are relatively scattered, the frequency domain resources of a single band are relatively narrow. If PDSCH resource allocation is restricted to one band, frequency diversity gain cannot be obtained or the obtained frequency diversity gain is limited.

In order to obtain better frequency diversity gain and anti-interference performance, frequency hopping transmission may also be adopted for downlink transmission, and different hops of one transmission may be performed in different bands. For example, the base station configures or enables downlink transmission for frequency hopping transmission through higher layer signaling. In addition, since the number of resource blocks (RB) allocated for PDSCH resources is usually relatively large, when performing frequency hopping transmission, the base station ensures that the frequency domain unit configured or indicated for each hop has sufficient RBs for PDSCH transmission; or when the terminal determines the frequency domain unit based on the configuration or indication of the base station, if the frequency domain resources included in the frequency domain unit cannot satisfy the PDSCH transmission, that is, the frequency domain unit is unavailable, the terminal may not perform frequency hopping or may find another frequency domain unit that meets requirements for transmission.

### Embodiment 3

FIG. 8 is a fifth schematic diagram of a frequency domain unit index of each hop of PUCCH transmission according to an embodiment of this application. As shown in FIG. 8, for one PUCCH or PUSCH transmission, the terminal may determine, based on the configuration or indication of the base station, to transmit the first hop in BWP0 and transmit the second hop in BWP2, but PUCCH or PUSCH cannot be transmitted at a frequency domain position corresponding to the second hop. In FIG. 8, a symbol position for the PUCCH or PUSCH is configured as a DL symbol. In one implementation, the terminal cancels frequency hopping transmission and transmits the first hop and the second hop in BWP0. In another implementation, the terminal switches transmission of the second hop to another frequency domain unit according to a predefined rule, for example, transmits the second hop on an available or activated BWP (BWP1 in FIG. 8) that has a largest gap from a frequency domain unit in which the first hop is located.

The frequency hopping transmission method according to the embodiments of this application may be executed by a frequency hopping transmission apparatus. In the embodiments of this application, the frequency hopping transmission method being executed by a frequency hopping transmission apparatus is used as an example to describe a frequency hopping transmission apparatus according to an embodiment of this application.

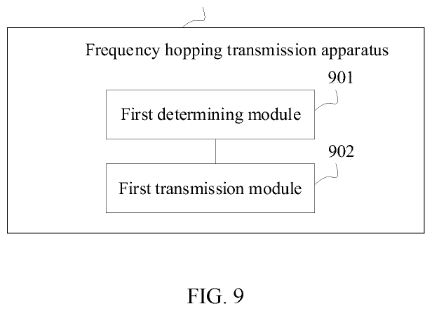

FIG. 9 is a schematic structural diagram of a frequency hopping transmission apparatus according to an embodiment of this application. As shown in FIG. 9, the frequency hopping transmission apparatus 900 includes: a first determining module 901 and a first transmission module 902; where
the first determining module 901 is configured to determine, based on target information or a predefined rule, a frequency domain unit in which each hop of at least two hops of a first transmission is located; where the target information is used for indicating a frequency domain unit in which at least one hop of the at least two hops is located; the predefined rule is used for determining the frequency domain unit in which at least one hop of the at least two hops is located; and the first transmission supports frequency hopping transmission on different frequency domain units; and
the first transmission module 902 is configured to perform transmission on the frequency domain unit in which at least one hop of the at least two hops is located.

The frequency hopping transmission apparatus according to the embodiment of this application determines, based on target information or a predefined rule, a frequency domain unit in which each hop of at least two hops of a first transmission is located; where the target information is used for indicating a frequency domain unit in which at least one hop of the at least two hops is located; the predefined rule is used for determining the frequency domain unit in which at least one hop of the at least two hops is located; and the first transmission supports frequency hopping transmission on different frequency domain units. This allows the terminal to perform transmission on the frequency domain unit in which at least one hop of the at least two hops is located, thereby implementing frequency hopping transmission of the first transmission between different frequency domain units, that is, performing frequency hopping transmission on one or more non-contiguous frequency domain resources, thereby obtaining relatively high frequency diversity gain or enhancing anti-interference capability for uplink transmission, reducing transmission latency of the first transmission, and improving performance of a communication system.

Optionally, the target information includes at least one of the following:
first information, used for indicating the frequency domain unit in which each hop of the at least two hops is located;
second information, used for indicating a frequency domain unit index of a first hop;
a first frequency domain unit offset; where the first frequency domain unit offset is used for indicating an offset of a frequency domain unit index of each hop starting from a second hop relative to a frequency domain unit index of a first hop, or an offset relative to a frequency domain unit index of a previous hop, or a minimum offset;
a first frequency domain unit offset list; where the first frequency domain unit offset list includes at least one second frequency domain unit offset, and the second frequency domain unit offset is used for indicating an offset of a frequency domain unit index of each hop starting from a second hop relative to a frequency domain unit index of a first hop, or an offset relative to a frequency domain unit index of a previous hop, or a minimum offset;
at least one frequency domain unit pair; where the frequency domain unit pair is used for indicating a frequency domain unit associated with a frequency domain unit in which a first hop is located;
a first frequency domain unit list; where the first frequency domain unit list is used for indicating a frequency domain unit index of each hop starting from a second hop;
a second frequency domain unit list; where the second frequency domain unit list is used for indicating a frequency domain unit index of each hop of the at least two hops; or
a frequency hopping pattern, used for indicating the frequency domain unit in which each hop of the at least two hops is located.

Optionally, the frequency hopping transmission apparatus 900 further includes:
a receiving module configured to receive higher layer signaling or dynamic signaling sent by a network-side device, where the higher layer signaling is used for configuring the target information, and the dynamic signaling is used for indicating the target information.

Optionally, a manner of acquiring the frequency domain unit index of the first hop is the same as or different from a manner of acquiring the frequency domain unit index of each hop starting from the second hop.

Optionally, the frequency hopping transmission apparatus 900 further includes:
a second determining module configured to determine a frequency domain unit index of an h-th hop based on the frequency domain unit index of the first hop and the first frequency domain unit offset; where h is an integer greater than 1;
or
a third determining module configured to determine a frequency domain unit index of an (m+1)-th hop based on a frequency domain unit index of an m-th hop and the first frequency domain unit offset; where m is an integer greater than 0.

Optionally, the third determining module is specifically configured to:
determine the frequency domain unit index of an (m+1)-th hop to be (Nₘ+offset1*n) based on a frequency domain unit index Nₘ of an m-th hop and the first frequency domain unit offset offset1; where n satisfies at least one of the following: n is a smallest positive integer for which a frequency domain unit with the frequency domain unit index (Nₘ+offset1*n) is available; n is less than or equal to a first value; or n is a predefined integer.

Optionally, the frequency hopping transmission apparatus 900 further includes:
a fourth determining module configured to determine a frequency domain unit index of an (i+1)-th hop based on the frequency domain unit index of the first hop and an i-th second frequency domain unit offset in the frequency domain unit offset list; where i is a positive integer;
or
a fifth determining module configured to determine a frequency domain unit index of an (i+1)-th hop based on the frequency domain unit index N₁ of the first hop and a j-th second frequency domain unit offset offsetⱼ in the first frequency domain unit offset list; where j is greater than or equal to i and is a smallest positive integer for which a frequency domain unit with a frequency domain unit index (N₁+offsetⱼ) is available;
or
a sixth determining module configured to determine a frequency domain unit index of a (g+1)-th hop based on a frequency domain unit index of a g-th hop and a g-th second frequency domain unit offset in the first frequency domain unit offset list; where g is an integer greater than 0;
or
a seventh determining module configured to determine a frequency domain unit index of a (g+1)-th hop to be (N_{g}+offsetₓ) based on a frequency domain unit index N_{g} of a g-th hop and an x-th second frequency domain unit offset offsetₓ in the first frequency domain unit offset list; where g is an integer greater than 1, and x is greater than or equal to g and is a smallest positive integer for which a frequency domain unit with the frequency domain unit index (N_{g}+offsetₓ) is available;
or
an eighth determining module configured to determine a frequency domain unit index of a (q+1)-th hop to be

$${N}_{q} + {\sum }_{j = k}^{j = k + p} {offset}_{j}$$

based on a frequency domain unit index N_{q} of a q-th hop and a k-th second frequency domain unit offset and p second frequency domain unit offsets after the k-th second frequency domain unit offset in the frequency domain unit offset list, where p is a smallest positive integer for which a frequency domain unit with the frequency domain unit index

$${N}_{q} + {\sum }_{j = k}^{j = k + p} {offset}_{j} ,$$

q is an integer greater than or equal to 1, offsetⱼ represents a j-th second frequency domain unit offset in the first frequency domain unit offset list, and k−1 is an index of a second frequency domain unit offset used for determining a (q−1)-th hop in the first frequency domain offset list.

Optionally, the frequency hopping transmission apparatus 900 further includes:
a ninth determining module configured to, in a case that the frequency domain unit index obtained based on the first frequency domain unit offset or the second frequency domain unit offset is greater than a maximum frequency domain unit index in configured or activated frequency domain units, determine, by using a wrap-around or modulo operation, the frequency domain unit index of each hop starting from the second hop.

Optionally, in a case that the target information includes the at least one frequency domain unit pair, the first determining module 801 is specifically configured to:
determine, based on each of the at least one frequency domain unit pair, the frequency domain unit index of each hop starting from the second hop; and
determine, based on the frequency domain unit index of the first hop and the frequency domain unit index of each hop starting from the second hop, the frequency domain unit in which each hop of the at least two hops of the first transmission is located.

Optionally, in a case that the target information includes the first frequency domain unit list, the first determining module 801 is specifically configured to:
determine, based on the first frequency domain unit list and according to an order of frequency domain unit indexes in the first frequency domain unit list corresponding sequentially to the frequency domain unit index of each hop starting from the second hop, the frequency domain unit index of each hop starting from the second hop; and
determine, based on the frequency domain unit index of the first hop and the frequency domain unit index of each hop starting from the second hop, the frequency domain unit in which each hop of the at least two hops of the first transmission is located.

Optionally, the first determining module 901 is further configured to:
in a case that the first target frequency domain unit determined according to an order of frequency domain unit indexes in the first frequency domain unit list corresponding sequentially to the frequency domain unit index of each hop starting from the second hop is unavailable, sequentially proceed to a next frequency domain unit of the first target frequency domain unit until a determined frequency domain unit is available or until a last frequency domain unit in the first frequency domain unit list is reached.

Optionally, in a case that the target information includes the second frequency domain unit list, the first determining module 801 is specifically configured to:
determine, based on the second frequency domain unit list and according to an order of frequency domain unit indexes in the second frequency domain unit list, the frequency domain unit in which at least one hop of the at least two hops of the first transmission is located;
or
in a case that a second target frequency domain unit determined based on an order of frequency domain unit indexes in the second frequency domain unit list is unavailable, sequentially proceed to a next frequency domain unit of the second target frequency domain unit until a determined frequency domain unit is available or until a last frequency domain unit in the second frequency domain unit list is reached.

Optionally, the frequency hopping transmission apparatus 900 further includes:
a second transmission module configured to, in a case that any one frequency domain unit determined by a terminal based on the target information is unavailable, perform transmission based on any one of the following:
canceling transmission of a hop corresponding to the any one frequency domain unit of the first transmission;
switching transmission of a hop corresponding to the any one frequency domain unit of the first transmission to another available frequency domain unit for transmission; and
delaying transmission of a hop corresponding to the any one frequency domain unit of the first transmission to an available frequency domain unit corresponding to another available time unit for transmission.

Optionally, the frequency hopping transmission apparatus 900 further includes:
a fallback module configured to, in a case that only one hop of the at least two hops of the first transmission has an available frequency domain unit or the number of available frequency domain units is less than the first value, fall back from a frequency hopping mode to a non-frequency hopping mode or a non-inter-frequency domain unit frequency hopping mode.

Optionally, the first value is determined based on at least one of the following:
the maximum number of frequency hops;
network indication; or
protocol predefinition.

Optionally, the frequency domain unit being available includes at least one of the following:
the frequency domain unit being activated or in an activated state;
a transmission direction configured or indicated for a time domain position corresponding to the frequency domain unit being the same as that of the first transmission; or
a frequency domain resource for the first transmission being within an available resource range of the frequency domain unit.

Optionally, the frequency hopping mode of the first transmission is intra-slot frequency hopping, inter-slot frequency hopping, or inter-transmission occasion frequency hopping.

The frequency hopping transmission apparatus in the embodiments of this application may be an electronic device, such as an electronic device having an operating system, or a component in an electronic device, such as an integrated circuit or a chip. The electronic device may be a terminal, or may be another device different from a terminal. For example, the terminal may include but is not limited to the types of the terminal 11 listed above, and the another device may be a server, a network attached storage (NAS), or the like, which are not specifically limited in the embodiments of this application.

The frequency hopping transmission apparatus according to the embodiments of this application can implement the processes implemented by the method embodiments shown in FIG. 3 to FIG. 8, with the same technical effects achieved. To avoid repetition, details are not described herein again.

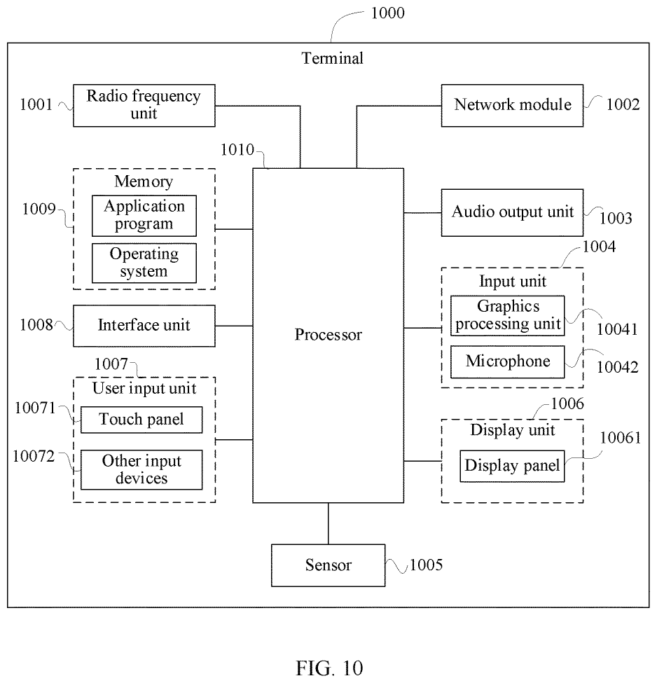

The embodiments of this application further provide a terminal including a processor and a communication interface, where the communication interface is coupled to the processor, and the processor is configured to run a program or instructions to implement the steps of the method embodiment shown in FIG. 3. This terminal embodiment corresponds to the foregoing terminal-side method embodiment, and the implementation processes and implementations of the foregoing method embodiment can all be applied to this terminal embodiment, with the same technical effects achieved. Specifically, FIG. 10 is a schematic diagram of a hardware structure of a terminal implementing the embodiments of this application.

The terminal 1000 includes but is not limited to at least some components of: a radio frequency unit 1001, a network module 1002, an audio output unit 1003, an input unit 1004, a sensor 1005, a display unit 1006, a user input unit 1007, an interface unit 1008, a memory 1009, a processor 1010, and the like.

Those skilled in the art can understand that the terminal 1000 may further include a power supply (such as a battery) supplying power to the components, and the power supply may be logically connected to the processor 1010 through a power management system, so as to implement functions such as charging management, discharging management, and power consumption management by using the power management system. The structure of the terminal shown in FIG. 10 does not constitute any limitation on the terminal. The terminal may include more or fewer components than shown in the figure, or a combination of some components, or the components disposed differently. Details are not described herein.

It should be understood that in the embodiments of this application, the input unit 1004 may include a graphics processing unit (GPU) 10041 and a microphone 10042. The graphics processing unit 10041 processes image data of a still picture or video obtained by an image capture apparatus (such as a camera) in a video capture mode or an image capture mode. The display unit 1006 may include a display panel 10061, and the display panel 10061 may be configured in the form of a liquid crystal display, an organic light-emitting diode, or the like. The user input unit 1007 includes at least one of a touch panel 10071 or other input devices 10072. The touch panel 10071 is also referred to as a touchscreen. The touch panel 10071 may include two parts: a touch detection apparatus and a touch controller. The other input devices 10072 may include but are not limited to a physical keyboard, a function key (such as a volume control key or an on/off key), a trackball, a mouse, and a joystick. Details are not described herein.

In the embodiments of this application, after receiving downlink data from a network-side device, the radio frequency unit 1001 may transmit the received downlink data to the processor 1010 for processing. In addition, the radio frequency unit 1001 may send uplink data to the network-side device. Typically, the radio frequency unit 1001 includes but is not limited to an antenna, an amplifier, a transceiver, a coupler, a low noise amplifier, and a duplexer.

The memory 1009 may be configured to store a software program or instructions and various data. The memory 1009 may mainly include a first storage area for storing programs or instructions and a second storage area for storing data. The first storage area may store an operating system, an application program or instructions required by at least one function (for example, a sound play function or an image play function), and the like. In addition, the memory 1009 may include a volatile memory or a non-volatile memory. The non-volatile memory may be a read-only memory (ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synch link dynamic random access memory (Synch link DRAM, SLDRAM), or a direct rambus random access memory (Direct Rambus RAM, DRRAM). The memory 1009 in the embodiments of this application includes but is not limited to these and any other suitable types of memory.

The processor 1010 may include one or more processing units. Optionally, the processor 1010 integrates an application processor and a modem processor. The application processor mainly processes operations related to an operating system, a user interface, an application program, or the like. The modem processor, such as a baseband processor, mainly processes radio communication signals. It can be understood that the modem processor may alternatively be not integrated into the processor 1010.

The processor 1010 is configured to determine, based on target information or a predefined rule, a frequency domain unit in which each hop of at least two hops of a first transmission is located; where the target information is used for indicating a frequency domain unit in which at least one hop of the at least two hops is located; the predefined rule is used for determining the frequency domain unit in which at least one hop of the at least two hops is located; and the first transmission supports frequency hopping transmission on different frequency domain units; and perform transmission on the frequency domain unit in which at least one hop of the at least two hops is located.

The terminal determines, based on target information or a predefined rule, a frequency domain unit in which each hop of at least two hops of a first transmission is located; where the target information is used for indicating a frequency domain unit in which at least one hop of the at least two hops is located; the predefined rule is used for determining the frequency domain unit in which at least one hop of the at least two hops is located; and the first transmission supports frequency hopping transmission on different frequency domain units. This allows the terminal to perform transmission on the frequency domain unit in which at least one hop of the at least two hops is located, implementing frequency hopping transmission of the first transmission between different frequency domain units, thereby obtaining sufficient frequency diversity gain and improving performance of the communication system.

It can be understood that for the implementation processes of the implementations mentioned in this embodiment, reference may be made to the relevant descriptions of the frequency hopping transmission method in the method embodiments, and the same or corresponding technical effects can be achieved. To avoid repetition, details are not described herein again.

The embodiments of this application further provide a readable storage medium, where a program or instructions are stored on the readable storage medium, and when the program or instructions are executed by a processor, the processes of the foregoing frequency hopping transmission method embodiments can be implemented, with the same technical effects achieved. To avoid repetition, details are not described herein again.

The processor is a processor in the terminal described in the foregoing embodiments. The readable storage medium includes a computer-readable storage medium, such as a computer read-only memory ROM, a random access memory RAM, a magnetic disk, or a compact disc. In some examples, the readable storage medium may be a non-transitory readable storage medium.

An embodiment of this application further provides a chip. The chip includes a processor and a communication interface, where the communication interface is coupled to the processor, the processor is configured to run a program or instructions to implement the processes of the foregoing frequency hopping transmission method embodiments, with the same technical effects achieved. To avoid repetition, details are not described herein again.

It should be understood that the chip mentioned in the embodiments of this application may also be referred to as a system-level chip, a system chip, a chip system, a system on chip, or the like.

An embodiment of this application further provides a computer program/program product, where the computer program/program product is stored in a storage medium, and the computer program/program product is executed by at least one processor to implement the processes of the foregoing frequency hopping transmission method embodiments, with the same technical effects achieved. To avoid repetition, details are not described herein again.

In the embodiments of this application, a terminal determines, based on target information or a predefined rule, a frequency domain unit in which each hop of at least two hops of a first transmission is located; where the target information is used for indicating a frequency domain unit in which at least one hop of the at least two hops is located; the predefined rule is used for determining the frequency domain unit in which at least one hop of the at least two hops is located; and the first transmission supports frequency hopping transmission on different frequency domain units. This allows the terminal to perform transmission on the frequency domain unit in which at least one hop of the at least two hops is located, thereby implementing frequency hopping transmission of the first transmission between different frequency domain units. Further, this can achieve a relatively high frequency diversity gain or improve an interference resistance capability of uplink transmission, reduce a transmission latency of the first transmission, and improve performance of a communication system.

It should be noted that in this specification, the terms “include”, “comprise”, or any of their variants are intended to cover a non-exclusive inclusion, such that a process, method, article, or apparatus that includes a series of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

By means of the foregoing description of the implementations, those skilled in the art may clearly understand that the method in the foregoing embodiments may be implemented by a computer software product with a necessary general hardware platform. Certainly, the method in the foregoing embodiments may also be implemented by hardware. The computer software product is stored in a storage medium (such as a ROM, a RAM, a magnetic disk, or a compact disc), and includes several instructions for instructing a terminal or a network-side device to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. As instructed by this application, persons of ordinary skill in the art may develop many other implementations without departing from principles of this application and the protection scope of the claims, and all such implementations shall fall within the protection scope of this application.

What is claimed is:

1. A frequency hopping transmission method, comprising:
determining, by a terminal based on target information or a predefined rule, a frequency domain unit in which each hop of at least two hops of a first transmission is located; wherein the target information is used for indicating the frequency domain unit in which at least one hop of the at least two hops is located; the predefined rule is used for determining the frequency domain unit in which at least one hop of the at least two hops is located; and the first transmission supports frequency hopping transmission on different frequency domain units; and
performing, by the terminal, transmission on the frequency domain unit in which at least one hop of the at least two hops is located.

2. The frequency hopping transmission method according to claim 1, wherein the target information comprises at least one of the following:
first information, used for indicating the frequency domain unit in which each hop of the at least two hops is located;
second information, used for indicating a frequency domain unit index of a first hop;
a first frequency domain unit offset; wherein the first frequency domain unit offset is used for indicating an offset of a frequency domain unit index of each hop starting from a second hop relative to a frequency domain unit index of a first hop, or an offset relative to a frequency domain unit index of a previous hop, or a minimum offset;
a first frequency domain unit offset list; wherein the first frequency domain unit offset list comprises at least one second frequency domain unit offset, and the second frequency domain unit offset is used for indicating an offset of a frequency domain unit index of each hop starting from a second hop relative to a frequency domain unit index of a first hop, or an offset relative to a frequency domain unit index of a previous hop, or a minimum offset;
at least one frequency domain unit pair; wherein the frequency domain unit pair is used for indicating a frequency domain unit associated with a frequency domain unit in which a first hop is located;
a first frequency domain unit list; wherein the first frequency domain unit list is used for indicating a frequency domain unit index of each hop starting from a second hop;
a second frequency domain unit list; wherein the second frequency domain unit list is used for indicating a frequency domain unit index of each hop of the at least two hops; or
a frequency hopping pattern, used for indicating the frequency domain unit in which each hop of the at least two hops is located.

3. The frequency hopping transmission method according to claim 1, wherein the method further comprises:
receiving, by the terminal, higher layer signaling or dynamic signaling sent by a network-side device, wherein the higher layer signaling is used for configuring the target information, and the dynamic signaling is used for indicating the target information.

4. The frequency hopping transmission method according to claim 2, wherein a manner of acquiring the frequency domain unit index of the first hop is the same as or different from a manner of acquiring the frequency domain unit index of each hop starting from the second hop.

5. The frequency hopping transmission method according to claim 2, wherein the method further comprises:
determining, by the terminal, a frequency domain unit index of an h-th hop based on the frequency domain unit index of the first hop and the first frequency domain unit offset; wherein h is an integer greater than 1;
or
determining, by the terminal, a frequency domain unit index of an (m+1)-th hop based on a frequency domain unit index of an m-th hop and the first frequency domain unit offset; wherein m is an integer greater than 0.

6. The frequency hopping transmission method according to claim 5, wherein the determining, by the terminal, a frequency domain unit index of an (m+1)-th hop based on a frequency domain unit index of an m-th hop and the first frequency domain unit offset comprises:
determining, by the terminal, the frequency domain unit index of the (m+1)-th hop to be (Nₘ+offset1*n) based on the frequency domain unit index Nₘ of the m-th hop and the first frequency domain unit offset offset1; wherein n satisfies at least one of the following: n is a smallest positive integer for which the frequency domain unit with the frequency domain unit index (Nₘ+offset1*n) is available; n is less than or equal to a first value; or n is a predefined integer.

7. The frequency hopping transmission method according to claim 2, wherein the method further comprises:
determining, by the terminal, a frequency domain unit index of an (i+1)-th hop based on the frequency domain unit index of the first hop and an i-th second frequency domain unit offset in the first frequency domain unit offset list; wherein i is a positive integer;
or
determining, by the terminal, a frequency domain unit index of an (i+1)-th hop based on the frequency domain unit index N₁ of the first hop and a j-th second frequency domain unit offset offsetⱼ in the first frequency domain unit offset list; wherein j is greater than or equal to i and is a smallest positive integer for which a frequency domain unit with a frequency domain unit index of (N₁+offsetⱼ) is available;
or
determining, by the terminal, a frequency domain unit index of a (g+1)-th hop based on a frequency domain unit index of a g-th hop and a g-th second frequency domain unit offset in the first frequency domain unit offset list; wherein g is an integer greater than 0;
or
determining, by the terminal, a frequency domain unit index of a (g+1)-th hop to be N_{g}+offsetₓ based on a frequency domain unit index N_{g} of a g-th hop and an x-th second frequency domain unit offset offsetₓ in the first frequency domain unit offset list; wherein g is an integer greater than 1, and x is greater than or equal to g and is a smallest positive integer for which a frequency domain unit with the frequency domain unit index (N_{g}+offsetₓ) is available;
or
determining, by the terminal, a frequency domain unit index of a (q+1)-th hop to be
$${N}_{q} + {\sum }_{j = k}^{j = k + p} {offset}_{j} ,$$
based on a frequency domain unit index N_{q} of a q-th hop and a k-th second frequency domain unit offset or p second frequency domain unit offsets after the k-th second frequency domain unit offset in the first frequency domain unit offset list, wherein p is a smallest positive integer for which a frequency domain unit with a frequency domain unit index of
$${N}_{q} + {\sum }_{j = k}^{j = k + p} {offset}_{j}$$
is available, q is an integer greater than or equal to 1, offsetⱼ represents a j-th second frequency domain unit offset in the first frequency domain unit offset list, and k−1 is an index of a second frequency domain unit offset used for determining a (q−1)-th hop in the first frequency domain offset list.

8. The frequency hopping transmission method according to claim 5, wherein the method further comprises:
in a case that the frequency domain unit index obtained based on the first frequency domain unit offset or the second frequency domain unit offset is greater than a maximum frequency domain unit index in configured or activated or available frequency domain units, determining, by the terminal by using a wrap-around or modulo operation, the frequency domain unit index of each hop starting from the second hop.

9. The frequency hopping transmission method according to claim 2, wherein in a case that the target information comprises the at least one frequency domain unit pair, the determining, by a terminal based on target information, a frequency domain unit in which each hop of at least two hops of first transmission is located comprises:
determining, by the terminal based on each of the at least one frequency domain unit pair, the frequency domain unit index of each hop starting from the second hop; and
determining, by the terminal based on the frequency domain unit index of the first hop and the frequency domain unit index of each hop starting from the second hop, the frequency domain unit in which each hop of the at least two hops of the first transmission is located.

10. The frequency hopping transmission method according to claim 2, wherein in a case that the target information comprises the first frequency domain unit list, the determining, by a terminal based on target information, a frequency domain unit in which each hop of at least two hops of a first transmission is located comprises:
determining, by the terminal based on the first frequency domain unit list and according to an order of frequency domain unit indexes in the first frequency domain unit list corresponding sequentially to the frequency domain unit index of each hop starting from the second hop, the frequency domain unit index of each hop starting from the second hop; and
determining, by the terminal based on the frequency domain unit index of the first hop and the frequency domain unit index of each hop starting from the second hop, the frequency domain unit in which each hop of the at least two hops of the first transmission is located.

11. The frequency hopping transmission method according to claim 10, wherein the determining, by the terminal based on the first frequency domain unit list and according to an order of frequency domain unit indexes in the first frequency domain unit list corresponding sequentially to the frequency domain unit index of each hop starting from the second hop, the frequency domain unit index of each hop starting from the second hop comprises:
in a case that a first target frequency domain unit determined by the terminal according to the order of the frequency domain unit indexes in the first frequency domain unit list corresponding sequentially to the frequency domain unit index of each hop starting from the second hop is unavailable, sequentially proceeding, by the terminal, to a next frequency domain unit of the first target frequency domain unit until a determined frequency domain unit is available or until a last frequency domain unit in the first frequency domain unit list is reached.

12. The frequency hopping transmission method according to claim 2, wherein in a case that the target information comprises the second frequency domain unit list, the determining, by a terminal based on target information, a frequency domain unit in which each hop of at least two hops of a first transmission is located comprises:
determining, by the terminal based on the second frequency domain unit list and according to an order of frequency domain unit indexes in the second frequency domain unit list, the frequency domain unit in which each hop of the at least two hops of the first transmission is located;
or
in a case that a second target frequency domain unit determined based on an order of frequency domain unit indexes in the second frequency domain unit list is unavailable, sequentially proceeding, by the terminal, to a next frequency domain unit of the second target frequency domain unit until a determined frequency domain unit is available or until a last frequency domain unit in the second frequency domain unit list is reached.

13. The frequency hopping transmission method according to claim 2, wherein the method further comprises:
in a case that any one frequency domain unit determined by the terminal based on the target information is unavailable, performing, by the terminal, transmission based on any one of the following:
canceling, by the terminal, transmission of a hop corresponding to the any one frequency domain unit of the first transmission;
switching, by the terminal, transmission of a hop corresponding to the any one frequency domain unit of the first transmission to another available frequency domain unit for transmission; and
delaying, by the terminal, transmission of a hop corresponding to the any one frequency domain unit of the first transmission to an available frequency domain unit corresponding to another available time unit for transmission.

14. The frequency hopping transmission method according to claim 6, wherein the method further comprises:
in a case that only one of the at least two hops of the first transmission has an available frequency domain unit or the number of available frequency domain units is less than the first value, falling back, by the terminal, from a frequency hopping mode to a non-frequency hopping mode or a non-inter-frequency domain unit frequency hopping mode.

15. The frequency hopping transmission method according to claim 6, wherein the first value is determined based on at least one of the following:
the maximum number of frequency hops;
network indication; or
protocol predefinition.

16. The frequency hopping transmission method according to claim 1, wherein the frequency domain unit being available comprises at least one of the following:
the frequency domain unit being activated or in an activated state;
a transmission direction configured or indicated for a time domain position corresponding to the frequency domain unit being the same as that of the first transmission; or
a frequency domain resource for the first transmission being within an available resource range of the frequency domain unit.

17. The frequency hopping transmission method according to claim 1, wherein a frequency hopping mode of the first transmission is intra-slot frequency hopping, inter-slot frequency hopping, or inter-transmission occasion frequency hopping.

18. A terminal, comprising:
a processor implemented in hardware and a memory, wherein the memory stores a program or instructions capable of running on the processor, and the program or instructions, when executed by the processor, implement:
determining, based on target information or a predefined rule, a frequency domain unit in which each hop of at least two hops of a first transmission is located; wherein the target information is used for indicating the frequency domain unit in which at least one hop of the at least two hops is located; the predefined rule is used for determining the frequency domain unit in which at least one hop of the at least two hops is located; and the first transmission supports frequency hopping transmission on different frequency domain units; and
performing transmission on the frequency domain unit in which at least one hop of the at least two hops is located.

19. A non-transitory computer-readable storage medium, wherein a program or instructions are stored on the readable storage medium, and the program or instructions, when executed by a hardware processor, implement:
determining, based on target information or a predefined rule, a frequency domain unit in which each hop of at least two hops of a first transmission is located; wherein the target information is used for indicating the frequency domain unit in which at least one hop of the at least two hops is located; the predefined rule is used for determining the frequency domain unit in which at least one hop of the at least two hops is located; and the first transmission supports frequency hopping transmission on different frequency domain units; and
performing transmission on the frequency domain unit in which at least one hop of the at least two hops is located.

20. The terminal according to claim 18, wherein the target information comprises at least one of the following:
first information, used for indicating the frequency domain unit in which each hop of the at least two hops is located;
second information, used for indicating a frequency domain unit index of a first hop;
a first frequency domain unit offset; wherein the first frequency domain unit offset is used for indicating an offset of a frequency domain unit index of each hop starting from a second hop relative to a frequency domain unit index of a first hop, or an offset relative to a frequency domain unit index of a previous hop, or a minimum offset;
a first frequency domain unit offset list; wherein the first frequency domain unit offset list comprises at least one second frequency domain unit offset, and the second frequency domain unit offset is used for indicating an offset of a frequency domain unit index of each hop starting from a second hop relative to a frequency domain unit index of a first hop, or an offset relative to a frequency domain unit index of a previous hop, or a minimum offset;
at least one frequency domain unit pair; wherein the frequency domain unit pair is used for indicating a frequency domain unit associated with a frequency domain unit in which a first hop is located;
a first frequency domain unit list; wherein the first frequency domain unit list is used for indicating a frequency domain unit index of each hop starting from a second hop;
a second frequency domain unit list; wherein the second frequency domain unit list is used for indicating a frequency domain unit index of each hop of the at least two hops; or
a frequency hopping pattern, used for indicating the frequency domain unit in which each hop of the at least two hops is located.
